(19) United States
(12) Patent Application Publication
(10) Pub. No.: US 2008/0198508 A1
(43) Pub. Date: Aug. 21, 2008

(54) MAGNETIC HEAD FOR PERPENDICULAR MAGNETIC RECORDING AND MAGNETIC DISK DRIVE

(75) Inventor: Kiyoshi Nishikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/027,754

(22) Filed: Feb. 7, 2008

(30) Foreign Application Priority Data
Feb. 15, 2007 (JP) 2007-034640
Sep. 19, 2007 (JP) 2007-242746

(51) Int. Cl. G11B 5/127

(52) U.S. Cl. 360/125.02

(57) ABSTRACT

There is provided a perpendicular recording magnetic head that is able to improve further the magnetic characteristic in writing the magnetic data by magnetizing a magnetic recording medium in the perpendicular direction rather than the prior art. In a perpendicular recording magnetic head, a recording magnetic field output surface of a main pole, which emits a recording magnetic field generated by an exciting coil toward a magnetic recording medium in the perpendicular direction, has a trapezoid shape in which a base on a leading side is longer than a base on a trailing side and has a distribution of a saturation magnetic flux density which is reduced from the trailing side to the leading side, whereby this structure contributes an improvement of the recording density.

### CROSS-RELATED APPLICATIONS

The present application claims priority to Japanese Patent Application 2007-034640, filed Feb. 15, 2007, and Japanese Patent Application 2007-242746, filed Sep. 19, 2007, the contents of which are incorporated herein by reference in their entirety.

### FIELD OF THE INVENTION

The present invention relates to a magnetic head for perpendicular magnetic recording and a magnetic disk drive and, more particularly, a magnetic head used in perpendicular recording magnetic data on a magnetic recording medium and a magnetic disk drive having the magnetic head.

### BACKGROUND OF THE INVENTION

In the magnetic disk drive, it is well known that magnetic data is recorded/played back on/from the magnetic recording medium, e.g., the magnetic disk, by using the magnetic head. In this case, a recording density must be improved in both the track width direction and the bit length direction in order to increase a storage capacity per unit area in the magnetic disk.

Meanwhile, in the in-plane recording system that is used frequently at present, it is known that a recording layer is thinned and a bit length is shortened to increase a recording density. In this case, the thinning recording layer causes the heat fluctuation of the magnetic recording medium which interferes with a higher recording density.

The perpendicular recording system which records magnetic information by magnetizing the magnetic recording medium in the perpendicular direction is promising as the method of solving this problem.

About an area of each magnetic domain on the surface of the recording layer, the perpendicular recording system can make the area small compared with the in-plane recording system, thereby the perpendicular recording system can attain a greater recording density. Also, since it has turned to the direction of the magnetization perpendicularly to the film surface of the recording layer in the perpendicular recording system, the recording density is not reduced even if the recording layer is thickened, and also a heat fluctuation phenomenon is hard to occur even if the recording layer is thinned.

In such perpendicular recording system, in order to get a high-quality recording/playing signal and a higher recording density, a coercive force of the recording layer must be enhanced. Also, since the perpendicular recording system must cause the recording layer to generate a high data recording magnetization, the soft magnetic backing layer (soft under layer: SUL) for filling the role to circulate a perpendicular recording magnetic field is formed under the recording layer.

Such soft magnetic backing layer can enhance a writing power of the magnetic head set over the recording layer, and can make the magnetic head to generate a recording magnetic field in excess of 10 tesla (T). Thus, the magnetic head can write a data in the recording layer having the relatively large coercive force in excess of 5 kilooersteds (kOes).

In the perpendicular recording system, as well as the in-plane recording system, the giant magnetoresistive (GMR) head, the tunneling magnetoresistive (TMR) head having a large reproducing output, and the like can be employed as the magnetic reproducing head for reproducing magnetic signal.

Even in the case of above perpendicular recording systems, in order to improve further the recording density in future, an improvement of the density in both the track width direction and the bit length direction is still needed. Especially a core width of the magnetic head must be controlled with high precision to improve a density in the track width direction.

Especially, in the case of the perpendicular recording, a shape of the floating surface of the end portion of the main pole constituting the recording magnetic head greatly affects the magnetizing pattern on the magnetic recording medium in principle. The main pole has a planar shape shown in FIG. 26, for example.

A main pole 100 shown in FIG. 26 is constructed by a yoke portion 100a of a square formed under a magnetizing coil 110, a converging portion 100b projected from a top end of the yoke portion 100a such that a width is narrowed down like a taper shape, and a fore-end portion 100c projected from a narrow end of the converging portion 100b and having a floating surface 101 at its top end.

Respective pertinent portions of the fore-end portion of the main pole of the recording magnetic head and the recording surface of the magnetic recording medium have a positional relationship shown in a plan view of FIG. 27, for example.

In FIG. 27, a symbol 101 denotes the floating surface of the fore-end portion 100c of the main pole 100, a symbol 101a denotes a leading-side edge of the floating surface 101, a symbol 101b denotes a trailing-side edge of the floating surface 101, symbols 102a, 102b denote a track of the magnetic disk respectively, a symbol 103 denotes a track pitch, and a symbol 104 denotes a yaw angle as an inclination of the floating surface 101 to tangent lines of the tracks 102a, 102b of the magnetic disk respectively. In this case, in the standard magnetic disk drive, the yaw angle 104 is in a range of almost ±15° to 20° at a maximum.

Japanese Patent Application Publication (KOKAI) 2002-92821-A discloses that the floating surface 101 of the main pole 100 as shown in FIG. 27 is shaped into an inverse trapezoid shape whose base on the trailing side is set wider than a base on the leading side. KOKAI 2002-92821 discloses that, since the floating surface 101 is formed into the inverse trapezoid shape in this manner, a reduction of the area protruded from the track of the fore-end portion 100c can be expected when the yaw angle 104 increases. The floating surface 101 is set opposite to a surface of the recording layer, and constitutes a part of the air bearing surface (ABS) or the medium opposing surface of the magnetic head.

However, as encircled by a broken-line circle in FIG. 27, when the leading-side edge 101a of the floating surface 101 of the main pole 100 that is scanning the track 102a protrudes into the adjacent track 102b because of the increase of the yaw angle 104, it is a matter of course that the possibility of erasing magnetic information in the adjacent track 102b is enhanced.

In future, in answer to the request for a further higher density of a recording data, widths of the tracks 102a, 102b are narrowed more and more, and bit lengths along the tracks 102a and 102b are shortened more and more. Accordingly, when the shape of the floating surface 101 of the main pole 100 is formed as the inverse trapezoid shape, the head magnetic field falls inevitable. Thus, such problems exist that the noise is increased more largely as the floating surface 101 comes closer to the track edge.

In contrast, Japanese Patent Application Publication (KOKAI) 2005-183002-A discloses that the main pole shape of the magnetic material layer having a high saturation magnetic flux density is stacked on an upper surface of the wider trailing-side edge 101b of the fore-end portion 100c of the inverse trapezoid shape of the main pole 100, in order to enhance the recording power. A width of the magnetic material layer is formed identically to a width of the trailing-side edge.

Also, when a width of the track is narrowed further in a situation without any regard for the geometrical protrusion from the track 102a or 102b due to the yaw angle 104, the signal on the adjacent track is erased readily because of an expansion of the magnetic field from the leading-side edge 101a. Also, since the magnetic material used as the main pole 100 is subject to restriction of the saturation magnetic flux density, an intensity of the head magnetic field passing through the fore-end portion 100c of the main pole 100 is also restricted in the perpendicular direction.

Accordingly, in the magnetic disk drive, as the means for realizing high-performance recording operation effectively and stably, the magnetic flux must be controlled such that the excessive magnetic flux is not supplied to the fore-end portion 100c of the main pole 100.

This is so because, when the saturation of the magnetic flux is caused in the fore-end portion 100c of the main pole 100, there is a danger that an unnecessary magnetic flux (magnetic field) is radiated from side portions of the main pole 100 except the floating surface 101 and rewrites the information being recorded on the adjacent track.

Also, Japanese Patent Application Publication (KOKAI) 2004-164715-A discloses that the auxiliary magnetic pole layer is formed on a part of the yoke portion 100a and a part of the taper portion 100b of the main pole 100 through the nonmagnetic layer, in order to increase the magnetic flux supplied to the fore-end portion 100c of the main pole 100. This auxiliary magnetic layer does not act to suppress the unnecessary magnetic field that extends to the periphery of the fore-end portion 100c of the main pole 100.

Also, Japanese Patent Application Publication (KOKAI) 2006-155867-A discloses that an auxiliary magnetic pole layer 111 is formed in contact with the undersurface of the yoke portion 100a of the main pole 100. This auxiliary magnetic pole layer has the same planar shape as the yoke portion 100a, and has a function of containing the main magnetic flux therein and supplying the contained magnetic flux to the fore-end portion 100c through the converging portion 100b.

However, the magnetic field beyond the saturation magnetic flux density and the expansion of the writing magnetic field caused due to a change of the yaw angle must be suppressed much more, in order to enhance the recording density further in the magnetic recording device.

### SUMMARY OF THE INVENTION

According to one aspect of an embodiment, there is provided a perpendicular recording magnetic head, which includes a first magnetic pole having a recording magnetic field output surface that is shaped into a trapezoid shape in which a base on a trailing side is longer than a base on a leading side and has a distribution of a saturation magnetic flux density of which is reduced from the trailing side to the leading side.

According to another aspect of an embodiment, there is provided a perpendicular recording magnetic head mounted on a slider having a medium opposing surface, which includes a first magnetic pole which is coupled magnetically in order of a fore-end portion, a converging portion, and a yoke portion from the medium opposing surface, and whose planar shape is formed such that the fore-end portion contains a recording core; and a second magnetic pole which is coupled magnetically at least to the yoke portion of the first magnetic pole, and whose planar shape is formed such that a length in a direction perpendicular to a core width direction of the recording core is longer than a length in the core width direction.

According to still another aspect of an embodiment, there is provided a perpendicular recording magnetic head mounted on a slider having a medium opposing surface, which includes a first magnetic pole which is coupled magnetically in order of a fore-end portion, a converging portion, and a yoke portion from the medium opposing surface, and whose saturation magnetic flux density is reduced from a trailing side to a leading side; and a second magnetic pole which is coupled magnetically at least to the yoke portion of the first magnetic pole and whose planar shape is formed such that a length in a direction perpendicular to a core width direction of the recording core is longer than a length in the core width direction.

Other systems, methods, features and advantages of the invention will be or will become apparent to those skilled in the art with reference to the following figures and detailed description. It is intended that all such additional systems, methods, features and advantages be included within this description, be within the scope of the invention, and be protected by the accompanying claims.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and in which:

FIG. 1 is a plan view showing an example of the inside of a magnetic disk drive to which a perpendicular recording magnetic head according to embodiments of the present invention is fitted;

FIG. 2 is a principal explanatory view showing a flow of a magnetic flux between the magnetic head and a magnetic disk in the perpendicular recording process;

FIGS. 3A and 3B are a principal front view and a principal side view showing a perpendicular recording magnetic head according to a first embodiment of the present invention respectively;

FIGS. 4A to 4C are fragmental enlarged explanatory views showing a main pole and its neighborhood in the perpendicular recording magnetic head according to the first embodiment of the present invention;

FIG. 5A is a fragmental plan view showing the main pole constituting the perpendicular recording magnetic head according to the first embodiment of the present invention when viewed from its floating surface, and FIG. 5B is a fragmental plan view showing the main pole constituting the perpendicular recording magnetic head in the prior art when viewed from its floating surface;

FIGS. 6A and 6B are charts of two-dimensional head magnetic field distributions showing results of the simulation applied to the main poles shown in FIG. 5A and FIG. 5B respectively;

FIG. 7 is a graph showing a head magnetic field distribution at a track center of the magnetic disk in the down track direction, for the purpose of comparison between the main pole according to the present invention (solid line) and the main pole in the prior art (broken line);

FIGS. 8A to 8E are fragmental sectional views showing the main pole in pertinent steps, to explain Example 1 of steps of forming the main pole according to the present invention;

FIGS. 9A to 9D are fragmental sectional views showing the main pole in pertinent steps, to explain Example 2 of steps of forming the main pole according to the present invention;

FIGS. 10A to 10K are longitudinal sectional views showing steps of manufacturing a magnetic head according to a second embodiment of the present invention;

FIGS. 11A to 11F are sectional views showing steps of manufacturing the magnetic head according to the second embodiment of the present invention when viewed from the medium opposing surface side;

FIGS. 12A to 12F are plan views showing steps of manufacturing the magnetic head according to the second embodiment of the present invention;

FIG. 13 is a pertinent side view showing an arrangement relation between a perpendicular recording magnetic head and a magnetic recording medium according to the second embodiment of the present invention;

FIGS. 14A and 14B are a front view and a side view showing arrangement relationships of a main pole and a main pole auxiliary layer constituting the perpendicular recording magnetic head to the magnetic recording medium according to the second embodiment of the present invention respectively;

FIG. 15 is a graph showing a relationship between a distance of the main pole auxiliary layer constituting the perpendicular recording magnetic head from the medium opposing surface and a recording magnetic field, in the second embodiment of the present invention and the prior art;

FIG. 16 is a graph showing a relationship between a distance of the main pole auxiliary layer constituting the perpendicular recording magnetic head from the medium opposing surface and an adjacent erase magnetic field, in the second embodiment of the present invention and the prior art;

FIGS. 17A and 17B are plan views showing another example of the main pole and the main pole auxiliary layer constituting the perpendicular recording magnetic head according to the second embodiment of the present invention respectively;

FIGS. 18A and 18B are a plan view and a side view showing an arrangement relationship between the main pole and the main pole auxiliary layer of the perpendicular recording magnetic head for reference purposes and the magnetic recording medium respectively;

FIG. 19 is a graph showing a relationship between a distance of the main pole auxiliary layer constituting the perpendicular recording magnetic head from the medium opposing surface and a recording magnetic field, in the second embodiment of the present invention and the prior art for reference purposes;

FIG. 20 is a graph showing a relationship between a distance of the main pole auxiliary layer constituting the perpendicular recording magnetic head from the medium opposing surface and an adjacent erase magnetic field, in the second embodiment of the present invention and the prior art for reference purposes;

FIGS. 21A and 21B are a plan view and a side view showing an arrangement relationship between the main pole and the main pole auxiliary layer constituting the perpendicular recording magnetic head for reference purposes and the magnetic recording medium respectively;

FIGS. 22A and 22B are a plan view and a side view showing a main pole and a main pole auxiliary layer constituting a perpendicular recording magnetic head according to a third embodiment of the present invention respectively;

FIGS. 23A and 23B are fragmental plan views showing the main pole constituting the perpendicular recording magnetic head according to the third embodiment of the present invention respectively when viewed from the floating surface;

FIG. 24 is a graph showing a relationship between a distance of the main pole auxiliary layer constituting the perpendicular recording magnetic head from the medium opposing surface and a recording magnetic field, in the second and third embodiments of the present invention respectively;

FIG. 25 is a graph showing a relationship between a distance of the main pole auxiliary layer constituting the perpendicular recording magnetic head from the medium opposing surface and an adjacent erase magnetic field, in the second and third embodiments of the present invention respectively;

FIG. 26 is a plan view showing a main pole constituting the perpendicular recording magnetic head in the prior art; and

FIG. 27 is a principal fragmental plan view showing a relationship between a main pole of a magnetic head and a recording surface of a magnetic disk.

### DESCRIPTION OF THE PREFERRED EMBODIMENTS

Embodiments of the present invention will be described in detail with reference to the drawings hereinafter. In the following description, for purposes of explanation, specific nomenclature is set forth to provide full understanding of the various inventive concepts disclosed herein. However, it will be apparent to those skilled in the art that these specific details may not be required in order to practice the various inventive concepts disclosed herein.

The inventor describes a perpendicular recording magnetic head that is capable of improving further the magnetic characteristic in writing magnetic data by magnetizing a magnetic recording medium in the perpendicular direction rather than the prior art, and a magnetic disk drive capable of having such a perpendicular recording magnetic head.

According to the feature of the present embodiment, saturation magnetic flux density of a first magnetic pole of a perpendicular recording magnetic head is distributed to reduce from a trailing side to a leading side. Therefore, even when the presence of a yaw angle in the recording magnetic field output is taken into consideration, interference on adjacent track can be reduced and recording density in track width direction can be improved. Also, writing magnetic field at a trailing edge is so steep that the recording density in a bit length direction can be high.

Also, magnetic material which has the good soft magnetic characteristic showing a low coercive force Hc and a small anisotropic magnetic field Hk is contained to occupy 50% or more of the overall first magnetic pole. Therefore, it is solvable also about the problem such that an erasure of the signal is caused by residual magnetization of the first magnetic pole immediately after the recording.

Further, a nonmagnetic layer of 2 nm to 5 nm thicknesses is inserted between stacked magnetic layers of the first magnetic pole. Therefore, the above problem can be improved much more. Also, this perpendicular recording magnetic head has a sufficient advantage from an aspect of a higher recording frequency corresponding to a high-speed data transmission.

Also, according to another feature of the present embodiment, in writing a magnetic data by magnetizing a magnetic recording medium in the perpendicular direction by a first magnetic pole of the perpendicular recording magnetic head, a second magnetic pole that is coupled magnetically with the first magnetic pole is arranged closer to a medium opposing surface side of the first magnetic pole rather than prior art. Therefore, a position of magnetic saturation can be set closer to the medium opposing surface than prior art, and expansion of saturation writing magnetic field can be suppressed rather than prior art.

### First Embodiment

FIG. 1 is a plan view showing an example of an internal structure of a magnetic disk drive according to embodiments of the present invention, in which the relation between a magnetic head and a magnetic disk is made clear.

In FIG. 1, a slider 13 is fixed to a top end of a suspension arm 12 that is supported by a rotary actuator 11 in a case 10. This slider 13 is fixed to the top end of the suspension arm 12 via a supporting tool called a ginbal whose illustration is omitted from FIG. 1. A magnetic head element portion 14 described later is fitted to an end portion of the slider 13.

The magnetic head element portion 14 records (writes)/plays back (reads) information on/from a magnetic disk 15 (magnetic recording medium) that turns counterclockwise in FIG. 1. Here, an arrow in FIG. 1 indicates the turning direction of the magnetic disk 15.

The magnetic head element portion 14 has a perpendicular recording head whose writing shield is arranged on the trailing side of the main pole, and a reproducing head using the magnetoresistive element, the tunneling magnetoresistive element, or the like.

The magnetic head element portion 14 is moved to a different radial position of the magnetic disk 15 and positioned there when the rotary actuator 11 turns. At this time, a plurality of concentric recording tracks is generated on the magnetic disk 15. An improvement of the density in the track width direction leads to a formation of a plurality of concentric recording tracks at a predetermined narrow interval.

A motion of the rotary actuator 11 explained above corresponds to a motion of the magnetic head element portion 14. Thus a recording/reproducing bit is decided by a correlation between a motion of the magnetic head element portion 14 and a motion of the magnetic disk 15, so that an angle between the magnetic head and the recording track, i.e., the yaw angle is changed variously in principle according to a difference in the disk radial position, and is changed in a range of ±15° to 20° at a maximum.

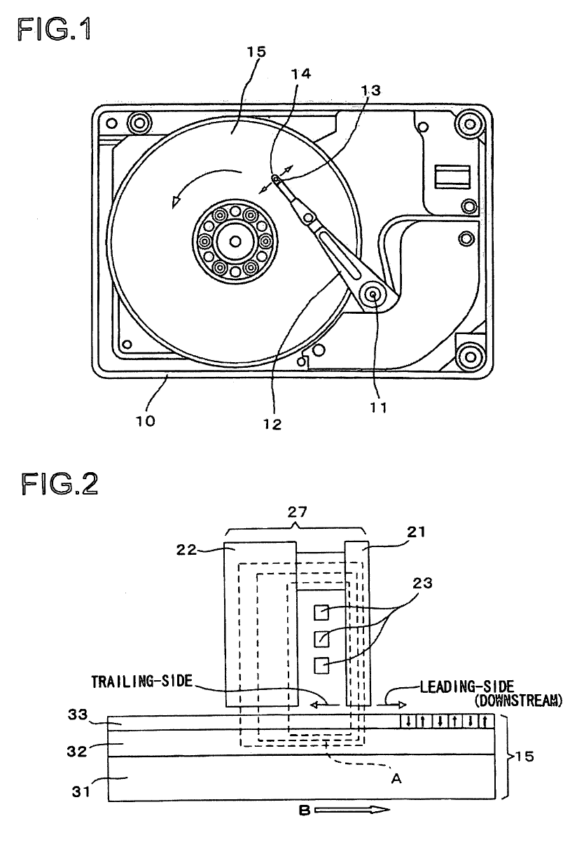

FIG. 2 is a principal sectional view showing a flow of a magnetic flux between the magnetic head and the magnetic disk in the perpendicular recording process in the magnetic disk drive according to the embodiment of the present invention, and also showing the perpendicular magnetic recording in principle. Here, the same reference symbols as those used in FIG. 1 denote the same portions or have the same meanings.

In FIG. 2, a perpendicular recording magnetic head 27 is constructed by a main pole 21, an auxiliary magnetic pole 22, and a conductive coil 23, and is arranged to oppose to a recording layer 33 of the magnetic disk 15 having a perpendicular recording structure. As indicated by a broken line in FIG. 2, the auxiliary magnetic pole 22 constitutes the top end of the main pole 21 and a part of the magnetic field route passing through the magnetic disk 15, and is called a return yoke.

The magnetic disk 15 has a backing layer 32 formed of a soft magnetic layer and formed on a substrate 31 made of the nonmagnetic material, and the recording layer 33 formed on the backing layer 32.

In this case, as the perpendicular recording magnetic head 27, there is the structure in which the conductive coil 23 is arranged on both the leading side and the trailing side of the main pole 21, described later.

When the perpendicular recording magnetic head 27 is excited by flowing a current through the conductive coil 23, a magnetic field is generated between the top end surface of the main pole 21 and the backing layer 32 in the perpendicular direction to a surface of the recording layer 33. Accordingly, the recording layer 33 of the magnetic disk 15 having the perpendicular recording structure is magnetized in the perpendicular direction and thus the data are recorded.

A plurality of rectangular broken lines indicated by a symbol A in FIG. 2 denote a flow path of the magnetic flux respectively. The magnetic field flowing in the soft magnetic backing layer 32 goes back to the main pole 21 via the auxiliary magnetic pole 22 to constitute the magnetic circuit. At this time, a magnetized state recorded on the magnetic disk 15 depends on a shape of the main pole of the floating surface of the perpendicular recording magnetic head 27 facing to the magnetic disk 15. In particular, it is understood that the recording is made on the downstream side in the traveling direction (turning direction) of the magnetic disk shown by an arrow indicated by a symbol B, i.e., the trailing-side edge of the main pole 21.

In this case, a schematic configuration of the magnetic disk drive shown in FIG. 1 and a principal view of the perpendicular magnetic recording shown in FIG. 2 are applied to plural embodiments described later respectively, except the configuration of the magnetic head element portion 14.

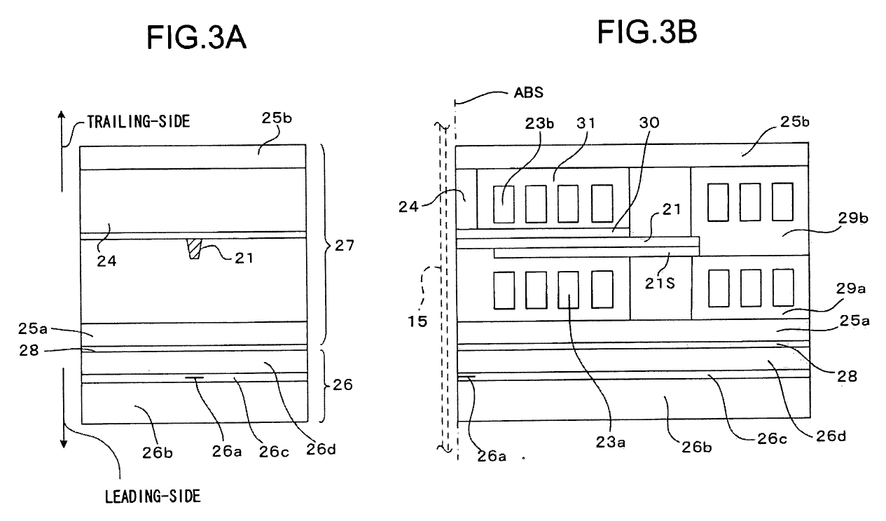

FIGS. 3A and 3B are principal explanatory views showing the overall perpendicular recording magnetic head according to the first embodiment of the present invention. FIG. 3A is a principal plan view explaining a configuration of a floating surface of the perpendicular recording magnetic head, and FIG. 3B is a principal longitudinal sectional view of a side surface explaining the configuration of the floating surface of the perpendicular recording magnetic head. Here, the same reference symbols as those used in FIG. 1 and FIG. 2 denote the same portions or have the same meanings.

In this case, it is appreciated that, since FIG. 3A shows the floating surface of the perpendicular recording magnetic head, the magnetic disk is positioned on the front side of the drawing at a slight distance from a sheet of the drawing.

In FIGS. 3A and 3B, a reference symbol 24 denotes a writing shield, reference symbols 25a, 25b denote first and second auxiliary magnetic poles respectively, and a reference symbol 26 denotes a magnetic reproducing head. As the magnetic reproducing head 26, a magnetoresistive element 26a such as the GMR element or the TMT element is employed.

The perpendicular recording magnetic head 27 is formed on the magnetic reproducing head 26 formed on a nonmagnetic substrate (not shown) via an isolation insulating layer 28. The magnetic reproducing head 26 has a nonmagnetic insulating gap layer 26c containing the magnetoresistive element 26a therein, and first and second reproducing-side magnetic shielding layers 26b, 26d formed to put the nonmagnetic insulating gap layer 26c between them.

The magnetic reproducing head 26 has a first conductive coil 23a buried in a first insulating layer 29a on the first auxiliary magnetic pole 25a, the main pole 21 formed over the first insulating layer 29a, a nonmagnetic gap layer 30 for covering the main pole 21, a second insulating layer 31 formed on the gap layer 30, a second conductive coil 23b buried in the second insulating layer 31, the second auxiliary magnetic pole 25b formed on the second insulating layer 29b, and the writing shield 24 formed on the gap layer 30 and connected to the fore-end portion of the second auxiliary magnetic pole 25b.

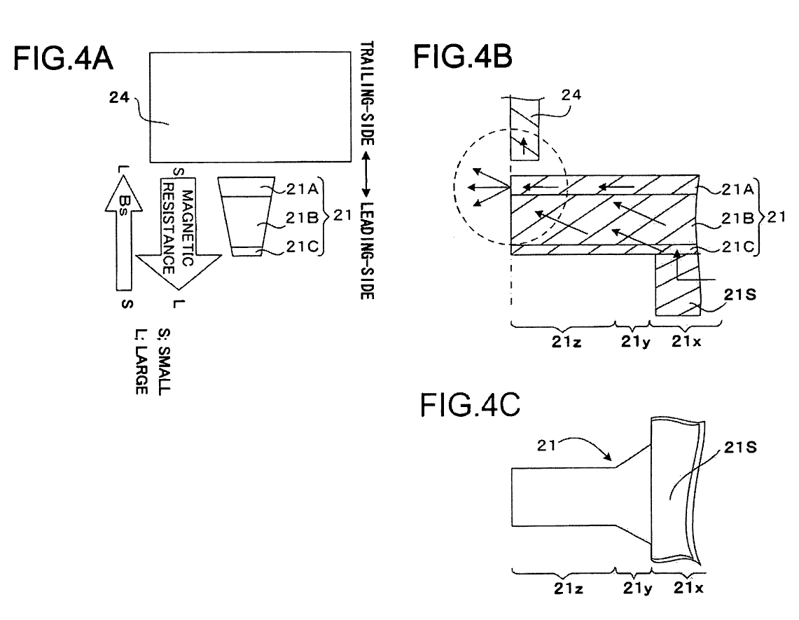

FIGS. 4A to 4C are fragmental enlarged explanatory views showing the main pole and its neighborhood in the perpendicular recording magnetic head explained in FIGS. 3A and 3B. FIG. 4A is a principal elevation view explaining a configuration of a floating surface of the main pole, FIG. 4B is a principal longitudinal sectional view explaining the same, and FIG. 4C is a principal plan view explaining the same. Here, the same reference symbols as those used in FIGS. 1, 2, 3A, and 3B denote the same portions or have the same functions.

As shown in FIGS. 4A to 4C, the features of the perpendicular recording magnetic head of the present embodiment appears conspicuously in the main pole 21. That is, the main pole 21 has the fore-end portion shaped into the inverse trapezoid in which the width of the trailing side is wider than that of the leading side, and a gradient is given to the saturation magnetic flux density Bs by stacking the magnetic materials whose saturation magnetic flux density Bs is selected to increase continuously in the film thickness direction from the leading side to the trailing side.

In other words, in the case of the illustrated example, the main pole 21 is formed of the stacked films made of at least three materials each having the different saturation magnetic flux density Bs. It is desirable that a magnetic layer 21A near the trailing edge should be formed of the magnetic material whose saturation magnetic flux density Bs is 2.0 T or more, whereas a magnetic layer 21C near the leading edge should be formed of the magnetic material whose saturation magnetic flux density Bs is 1.0 T or less. Also, it is desirable that a ratio of the saturation magnetic flux density Bs of the magnetic layer 21A on the trailing-edge side to the magnetic layer 21C on the leading-edge side should be 2.0 or more.

By way of concrete example, FeCo having the saturation magnetic flux density Bs=2.4 T can be used as the magnetic layer 21A on the trailing-edge side, and NiFe (a composition of Ni=70 wt % to 80 wt %) having the saturation magnetic flux density Bs=1.0 T can be used as the magnetic layer 21C on the leading-edge side. Also, FeNi (a composition of Fe=80% to 90%) having the saturation magnetic flux density Bs=2.1 T can be used as a magnetic layer 21B existing in the middle between them.

With such arrangement, it is a matter of course that the magnetic layer 21A on the trailing side has a small magnetic reluctance whereas the magnetic layer 21C on the leading side has a large magnetic reluctance.

In FIG. 4B, a main pole auxiliary layer 21S is formed on the surface of the magnetic layer 21A on the leading-edge side. Here, when the main pole 21 is assumed as the first magnetic pole and the main pole auxiliary layer 21S is assumed as the second magnetic pole, then the auxiliary magnetic pole 22 acts as the third magnetic pole. The

As shown in a plan view of FIG. 4C, the main pole auxiliary layer 21S is stacked only on a square yoke portion 21x of the main pole 21. A converging portion 21y whose width is narrowed forward like a taper shape is formed on a part of the yoke portion 21x constituting the main pole auxiliary layer 21S on the floating surface side to protrude from there, while a fore-end portion 21z having a floating surface at its top end is formed on the narrowed top end of the converging portion 21y to protrude from there.

In this case, as the structure of the perpendicular recording magnetic head other than the main pole 21 and the main pole auxiliary layer 21S, a structure shown in a second embodiment described later may be employed.

The main pole auxiliary layer 21S arranged to the main pole 21 on the leading-edge side is provided to concentrate the magnetic flux effectively to the neighborhood of the trailing edge of the main pole 21, as indicated by an arrow in the portion encircled by a broken line in FIG. 4B.

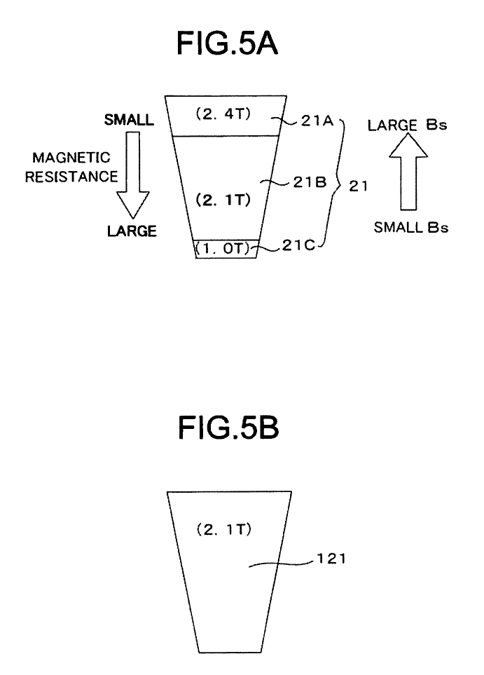

FIG. 5 is a fragmental plan view showing the main pole supposed to do a magnetic field simulation of the perpendicular recording magnetic head when viewed from its floating surface.

FIG. 5A shows the main pole of the first embodiment of the present invention, and FIG. 5B shows the main pole in the prior art.

In the case of FIG. 5A, a recording core width of the fore-end portion of the inverse trapezoid shape of the main pole 21 is set to 135 nm at the trailing edge. Also, when an overall film thickness of the main pole 21 is set to 250 nm, the main pole 21 is formed of the stacked films such that the saturation magnetic flux density Bs of the magnetic layer 21A located within a film thickness of 50 nm from the trailing edge is set to 2.4 T, the saturation magnetic flux density Bs of the magnetic layer 21C located within a film thickness of 50 nm from the leading edge is set to 1.0 T, and the saturation magnetic flux density Bs of the magnetic layer 21B located in an intermediate film thickness of 150 nm between them is set to 2.1 T.

Also, in the case of FIG. 5B, the simulation is done under the assumption that the overall main pole 121 is formed of the same magnetic material and the saturation magnetic flux density Bs is set to 2.1 T.

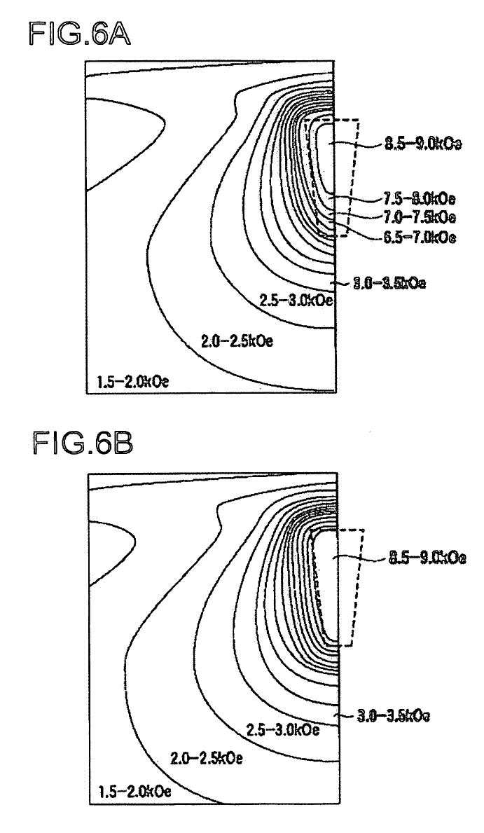

FIGS. 6A and 6B are charts showing two-dimensional head magnetic field distributions representing the results of the simulation applied to the main poles 21, 121 shown in FIGS. 5A and 5B respectively. FIG. 6A corresponds to the main pole 21 of the first embodiment of the present invention shown in FIG. 5A, and FIG. 6B corresponds to the main pole 121 in the prior art shown in FIG. 5B.

In both of FIGS. 6A and 6B, profiles of the main poles 21, 121 are indicated by a broken line respectively.

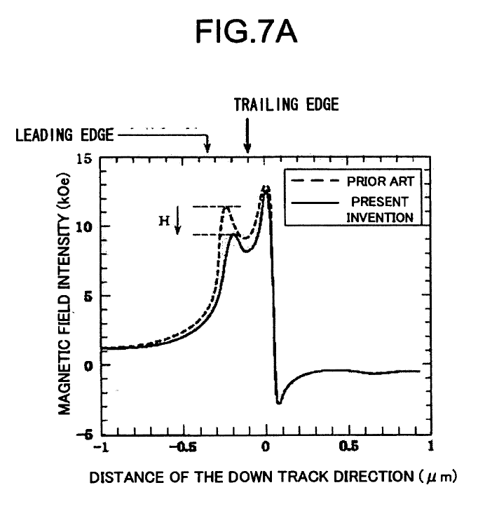

FIG. 7 shows the head magnetic field distribution at a track center of the magnetic disk in the down track direction, for the purpose of comparison between the main pole according to the present invention (solid line) and the main pole in the prior art (broken line).

In FIG. 7, an ordinate denotes a magnetic field strength (unit: kOe), and an abscissa denotes a distance (unit: μm) in the down-track direction. Also, an arrow H indicates a reduction of the magnetic field strength, and an amount of reduction of the magnetic field strength reaches 17%.

According to the main pole of the perpendicular recording magnetic head of the first embodiment of the present invention, it is appreciated that a magnitude of a leakage magnetic field near the leading edge could be suppressed rather than the main pole shown in FIG. 6B in the prior art.

According to FIG. 7, in the head magnetic field distribution in the down track direction, it is understood that a magnetic field strength of the main pole of the present invention near the trailing edge could be kept at the same level as a magnetic field strength of the main pole in the prior art near the trailing edge, but a magnetic field strength near the leading edge could be suppressed by about 17%.

In addition to the above advantage, it could be confirmed that, if the configuration of the main pole in the magnetic head of the present invention is employed, a head magnetic field gradient used to decide a transition width of the magnetic disk can be improved by about 3%.

With the above, according to the main pole in the magnetic head according to the first embodiment of the present invention, the influence of an expansion of the magnetic field from the leading edge can be reduced even when the yaw angle is considered. Thus, a density in the track width direction can be improved and a sufficiently large head magnetic field can be generated at the trailing edge of the main pole. Also, since a sharp magnetic field gradient can be realized at the trailing edge of the main pole, a density in the bit length direction can also be improved.

Also, since 50% or more of the overall film thickness of the main pole is occupied by the magnetic material whose soft magnetic characteristic is good to show a small coercive force Hc and a small anisotropic magnetic field Hk, such a problem can be overcome that a signal erasure is caused by the residual magnetization of the main pole immediately after the recording. Also, a further improvement can be attained, by inserting a nonmagnetic layer of 2 nm to 5 nm thicknesses between respective stacked films of the main pole,

Further, when the main pole is viewed from a viewpoint of a higher frequency of the recording frequency corresponding to a high-speed data transmission, normally a low coercive force Hc, a low anisotropic magnetic field Hk, a high resistivity ρ, and a high saturation magnetic flux density Bs are requested to reduce much more a hysteresis loss and an eddy-current loss of the main pole. Thus, since the nonmagnetic layer of 2 nm to 5 nm thickness is inserted between respective stacked films of the main pole, the main pole can be controlled to have the low coercive force Hc and the low anisotropic magnetic field Hk. Also, since the material having the high saturation magnetic flux density Bs is arranged to the trailing edge, the magnetic head that can inevitably deal with the high-frequency recording can be realized.

As described above, in the perpendicular recording magnetic head according to the first embodiment of the present invention, the main pole, particularly, the fore-end portion is shaped into the inverse trapezoid shape whose width is widened from the leading side to the trailing side, and is constructed by stacking the magnetic materials whose saturation magnetic flux density Bs is increased continuously or stepwise in the film thickness direction from the leading side to the trailing side.

According to this configuration, an expansion of the magnetic Field near the leading edge can be suppressed in the main pole, and the influence of the yaw angle on the adjacent track can be reduced. Also, the main pole is constructed by the magnetic materials such that the saturation magnetic flux density Bs near the trailing edge is set to 2.0 T or more and the saturation magnetic flux density Bs near the leading edge is set to 1.0 T or less. Thus, a gradient of the saturation magnetic flux density Bs is given in the film thickness direction of the main pole, and a magnetic field distribution at the trailing edge can be sharpened.

Hence, even though the yaw angle is taken into consideration, recording ooze (interference) to the adjacent track can be reduced, and an improvement in the density in the track width direction can be expected. Also, a writing operation can be carried out by using the sharp magnetic field at the trailing edge, and an improvement in the density in the bit length direction can be attained. As a result, the magnetic disk drive capable of executing the recording/reproducing at a high density can be provided.

Meanwhile, when the main pole 21 is constructed by a plurality of magnetic layers whose saturation magnetic flux density is different respectively, such a configuration may be employed that a plurality of magnetic layers are formed via a nonmagnetic material layer, e.g., a ruthenium (Ru) layer.

Next, two Examples of the method of forming the main pole of the magnetic recording head according to the first embodiment of the present invention will be explained hereunder. In this case, as steps of forming respective components except the main pole, steps illustrated in the second embodiment will be employed, for example.

### Example 1

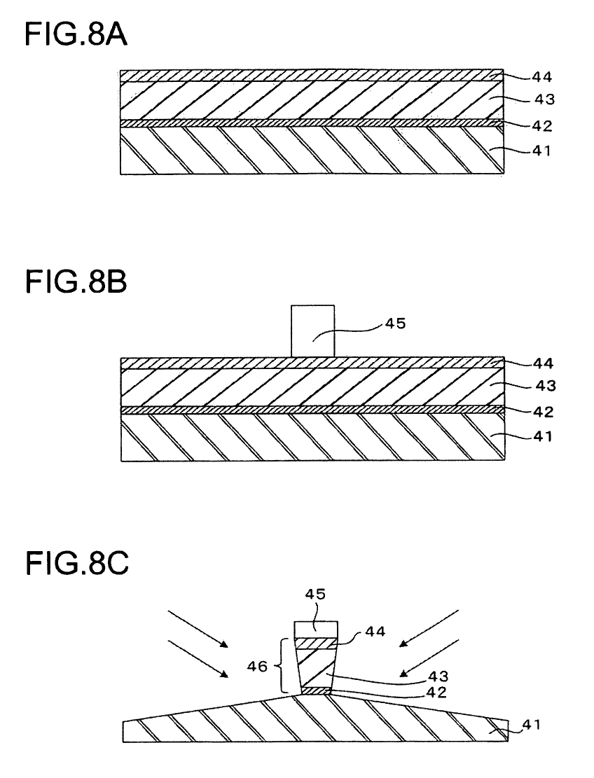

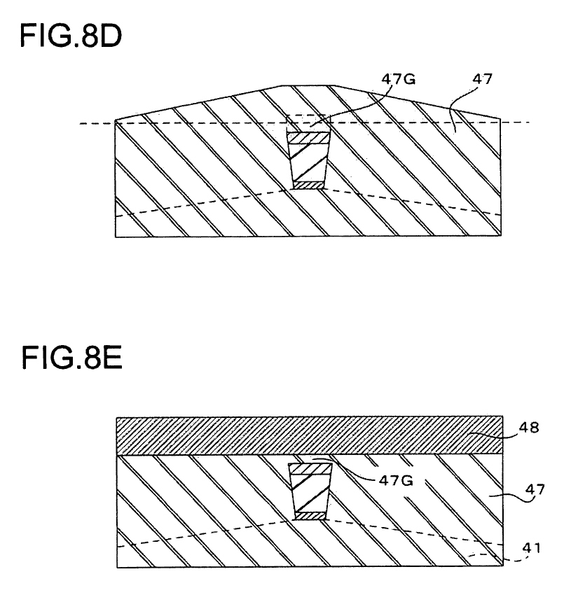

FIGS. 8A to 8E are principle sectional views showing Example 1 of steps of forming the main pole according to the first embodiment of the present invention. Respective steps will be explained with reference to these Figures hereunder.

First, as shown in FIG. 8A, the magnetic layers constituting the main pole were stacked and grown on an Al₂O₃ film as an inorganic insulating film 41 in order of the materials whose saturation magnetic flux density Bs is smaller, by applying the sputtering method. More concretely, these magnetic layers consisted of a first magnetic layer 42 made of FeNi (a composition of Fe=70 wt % to 80 wt %) equivalent to the saturation magnetic flux density Bs=1.0 T and having a thickness of 20 nm to 50 nm, a second magnetic layer 43 made of FeNi (a composition of Fe=80 wt % to 90 wt %) equivalent to the saturation magnetic flux density Bs=2.1 T and having a thickness of 150 nm to 200 nm, and a third magnetic layer 44 made of FeCo (a composition of Fe=60 wt % to 80 wt %) having the high saturation magnetic flux density Bs=2.4 T and having a thickness of 40 nm to 60 nm.

Then, as shown in FIG. 8B, a resist film 45 having patterns of the same width as a width of the main pole in the trailing side is formed on the third magnetic layer 44 by applying the resist process in the lithography technology.

Then, as shown in FIG. 8C, the third magnetic layer 44, the second magnetic layer 43, and the first magnetic layer 42 were etched anisotropically by applying the ion milling method while using the resist film 45 as a mask. Thus, a main pole 46 having the inverse trapezoid shape is formed. In this case, the overall main pole 46 containing the fore-end portion could be shaped into the inverse trapezoid shape.

Also, the ion milling method may be replaced with the dry etching method after an etching gas is selected appropriately. Concretely, the reactive ion etching may be applied while using an alumina film, i.e., an Al₂O₃ film or an inorganic insulating film such as SiO₂, or the like as a mask.

Then, as shown in FIG. 8D, the resist film 45 is removed. Then, an inorganic insulating film 47 made of alumina, SiO₂, or the like is formed by applying the CVD method to cover the main pole 46. Then, the inorganic insulating film 47 is polished and planarized by applying the chemical mechanical polishing (CMP).

This polishing of the inorganic insulating film 47 is executed to leave a thickness that is necessary to generate a gap 47G between the main pole 46 and the writing shield on the trailing side. Here, the writing shield on the trailing side is required to sharpen the magnetic field distribution in the bit length direction. By the way, the gap 47G should be set to almost 40 nm to 60 nm.

After the polishing of the inorganic insulating film 47 that makes it possible to generate the gap 47G is finished via such polishing step, as shown in FIG. 8E, a magnetic material film whose saturation magnetic flux density Bs is 1.4 T to 1.8 T is formed by applying the plating method or the sputtering method to the polished surface of the inorganic insulating film 47. Thus, a writing shield 48 is formed by the magnetic material film.

The magnetic flux generated by the coil 23 could be converged effectively to the trailing edge of the main pole 46 formed as above, as shown in FIGS. 3A and 3B. As a result, the sufficiently large head magnetic field could be generated, and the sharp magnetic field gradient could be obtained. This enables the magnetic head to improve the recording density in the bit length direction.

### Example 2

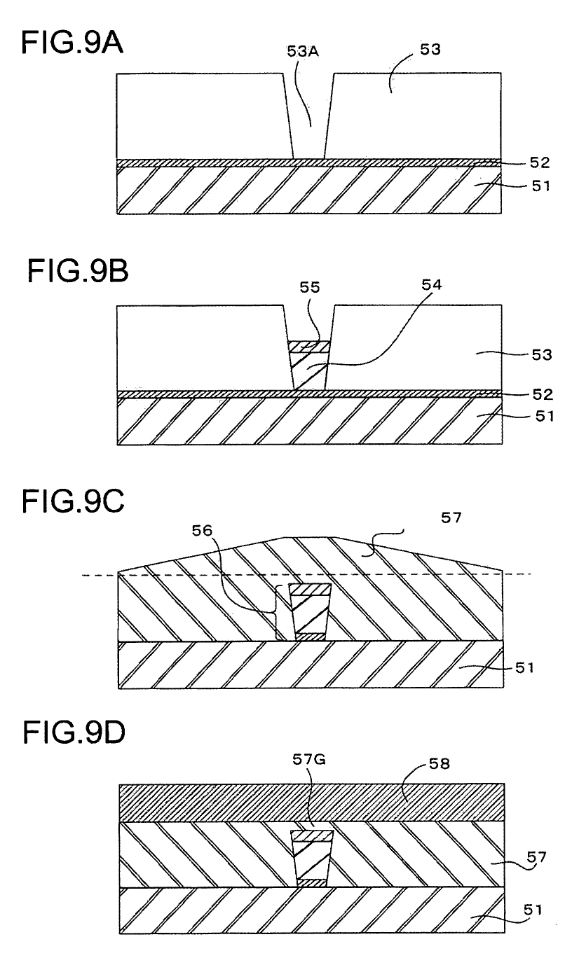

FIGS. 9A to 9D are principle sectional views showing Example 2 of steps of forming the main pole according to the first embodiment of the present invention. Here, the portions denoted by the same reference symbols as those used in FIGS. 1, 2, 3A, and 3B represent the same portions or have the same functions. Respective steps will be explained with reference to these Figures hereunder.

First, as shown in FIG. 9A, a first magnetic layer 52 of 20 nm to 50 nm thickness is formed on an Al₂O₃ film 51 as the inorganic insulating film by applying the sputtering method. This first magnetic layer 52 is made of FeNi (a composition of Fe=80 wt % to 90 wt %) equivalent to the saturation magnetic flux density Bs=1.0 T, and acted as a base film in executing the plating method.

Then, a resist film 53 is formed on the first magnetic layer 52 by applying the resist process in the lithography technology. An opening 53A used to form the main pole in the inverse trapezoid shape and having an inverse trapezoid sectional shape is patterned in this resist film 53.

Then, as shown in FIG. 9B, a second magnetic layer 54 is formed by applying the plating method. In this plating process, a composition ratio x of a Fe element out of a Fe element and a Ni element of the FeₓNi_{y} material is increased. Thus, the saturation magnetic flux density Bs of the second magnetic layer 54 is increased continuously in the film thickness direction from the leading side to the trailing side.

Then, a third magnetic layer 55 of 40 nm to 60 nm thickness is formed near the trailing edge on the second magnetic layer 54 by applying the plating method. This third magnetic layer 55 is made of FeNi (a composition of Fe=80 wt % to 90 wt %) whose saturation magnetic flux density Bs is 2.2 T. As this third magnetic layer 55, the magnetic material which is made of FeCo (a composition of Fe=60 wt % to 80 wt %) and whose saturation magnetic flux density Bs is large such as 2.4 T may be employed.

Then, the resist film 53 is removed. Then, as shown in FIG. 9C, the first magnetic layer 52 used as the base film in the plating process is patterned while using the second and third magnetic layers 54, 55 as a mask. Thus, a main pole 56 which has the inverse trapezoid shape and in which a gradient of the saturation magnetic flux density Bs is changed continuously in the film thickness direction from the leading side to the trailing side could be accomplished. Accordingly, the main pole 56 had the floating surface that consists of the first, second, third magnetic layers 52, 53, 54 and shaped into the inverse trapezoid shape.

Then, an inorganic insulating film 57 made of alumina, SiO₂, or the like is formed on the whole surface by applying the CVD method to cover the main pole 56. Then, as indicated by a broken line in FIG. 9C, the inorganic insulating film 57 is polished by applying the CMP method to planarize its upper surface. The upper surface of the main pole 56 acted as the edge of the main pole 56 on the trailing side. Also, the inorganic insulating film 57 located just above the main pole 56 gave a gap 57G between a writing shield 58 and the main pole 56, described later.

Then, the writing shield 58 is formed on the main pole 56 via the gap 57G by applying the sputtering method or the plating method. Thus, the perpendicular recording magnetic head of writing shield type is accomplished. Here, the gap 57G is set to almost 40 nm to 60 nm.

The perpendicular recording magnetic head having the main pole 56 manufactured as above in Example 2 could basically fulfill the same advantages as those of the perpendicular recording magnetic head according to other examples.

### Second Embodiment

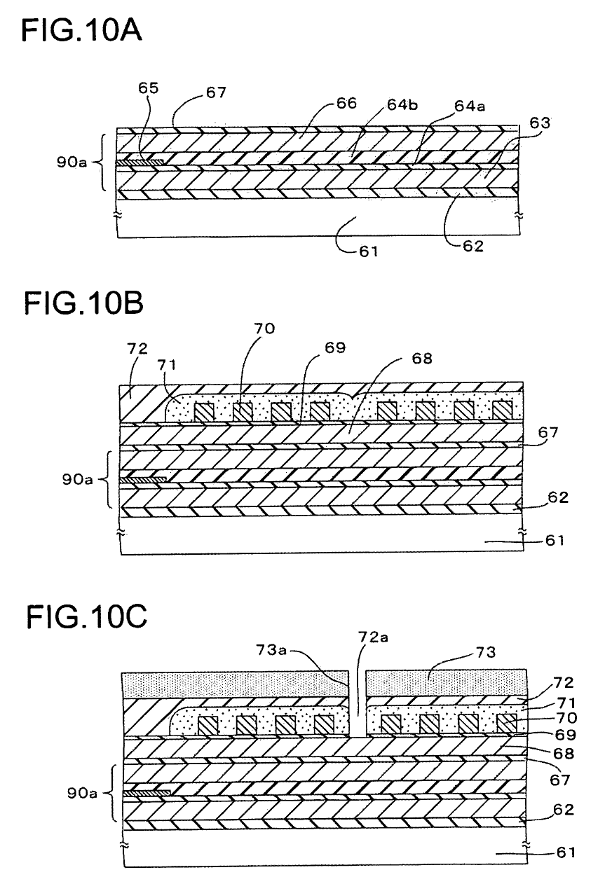

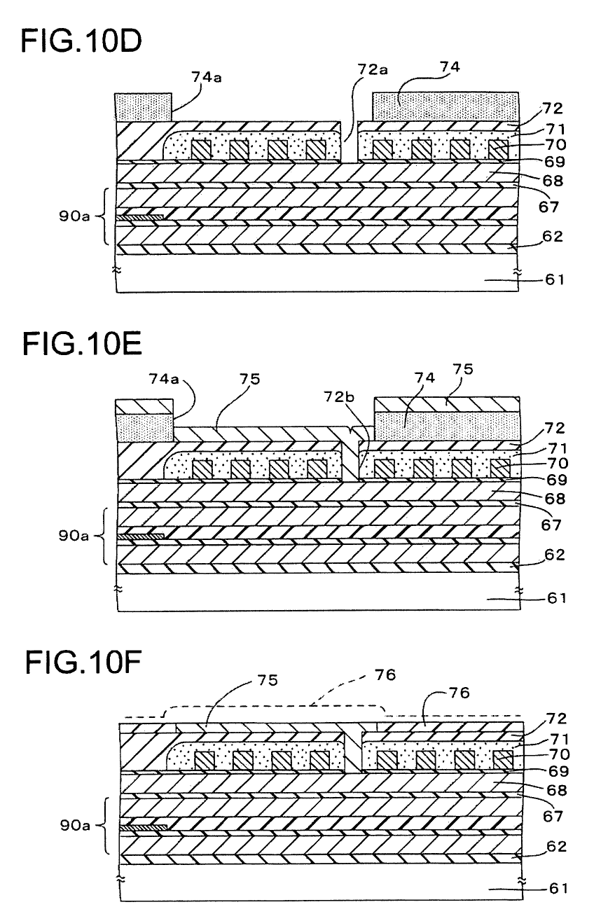

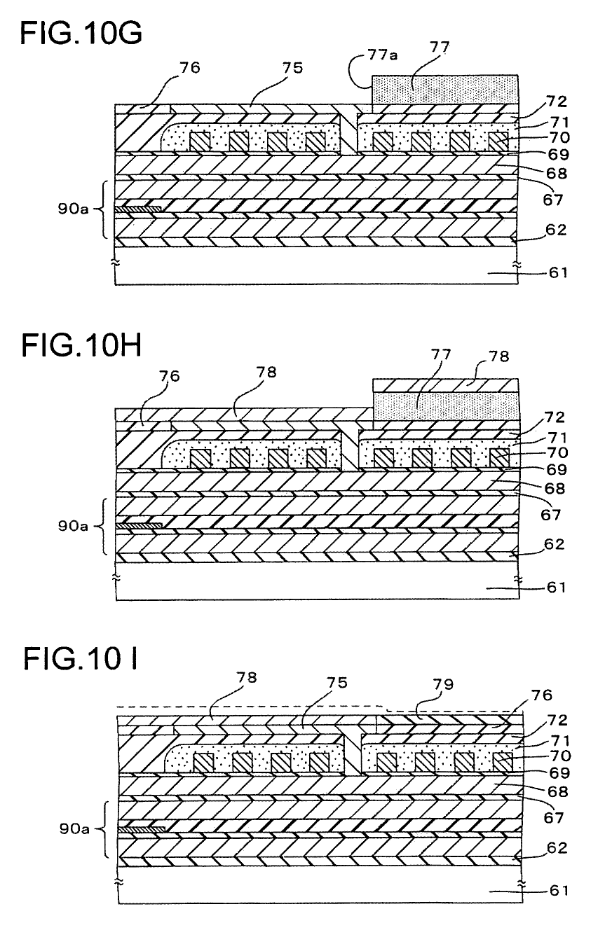

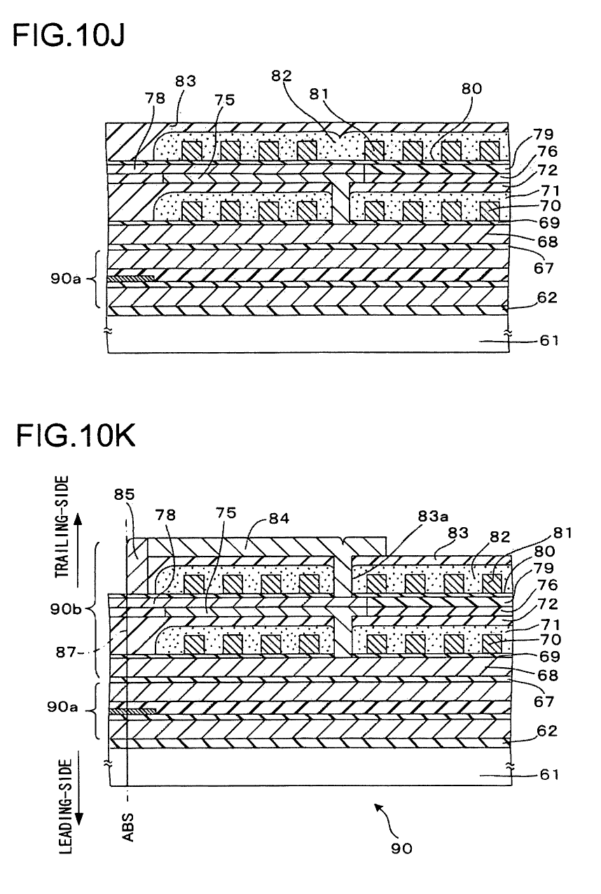

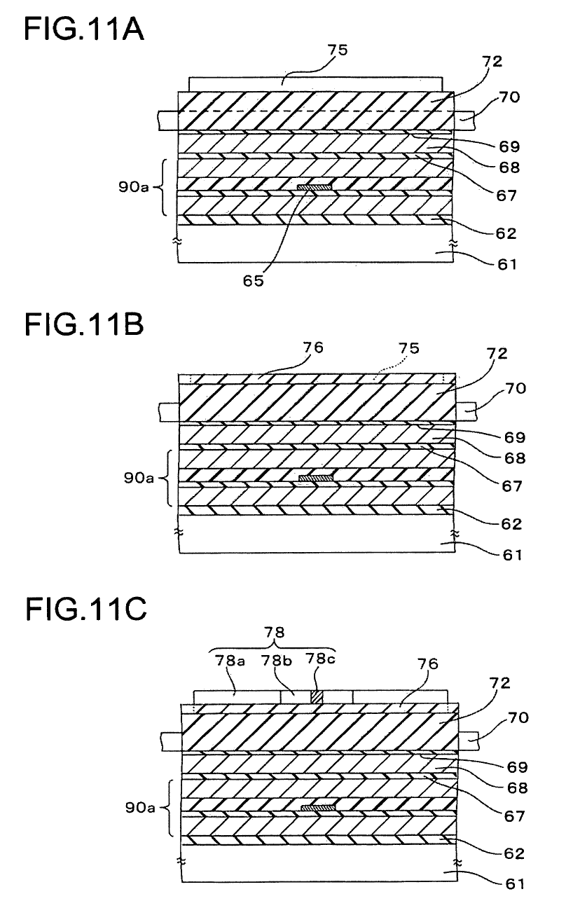

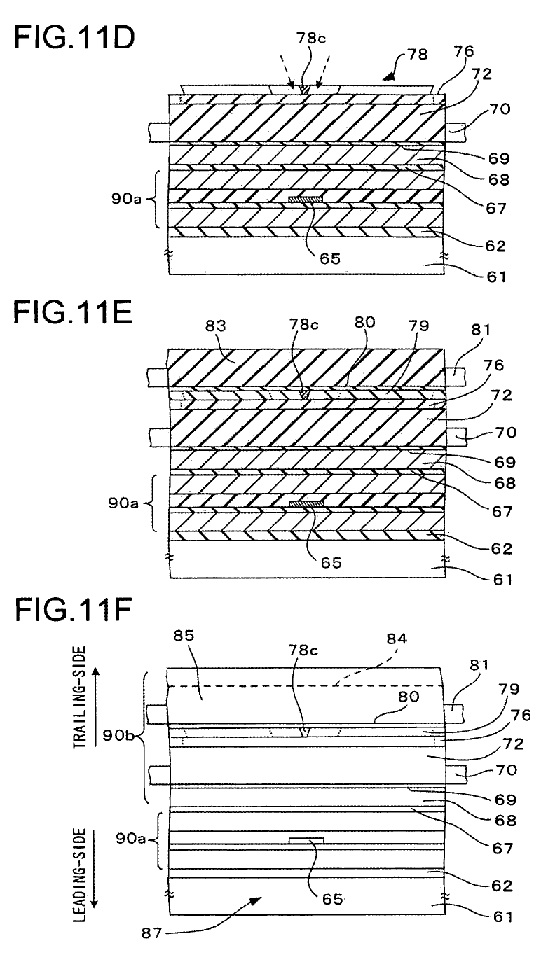

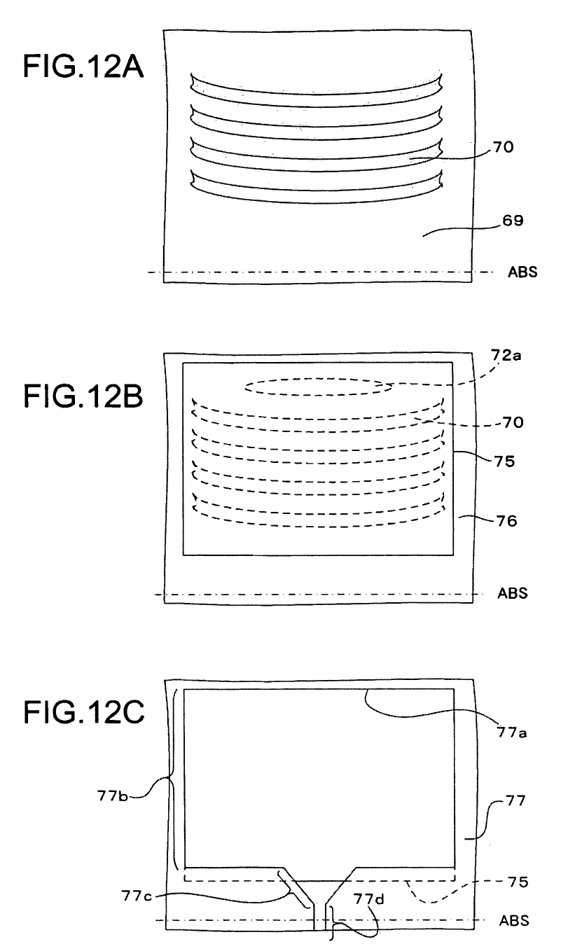

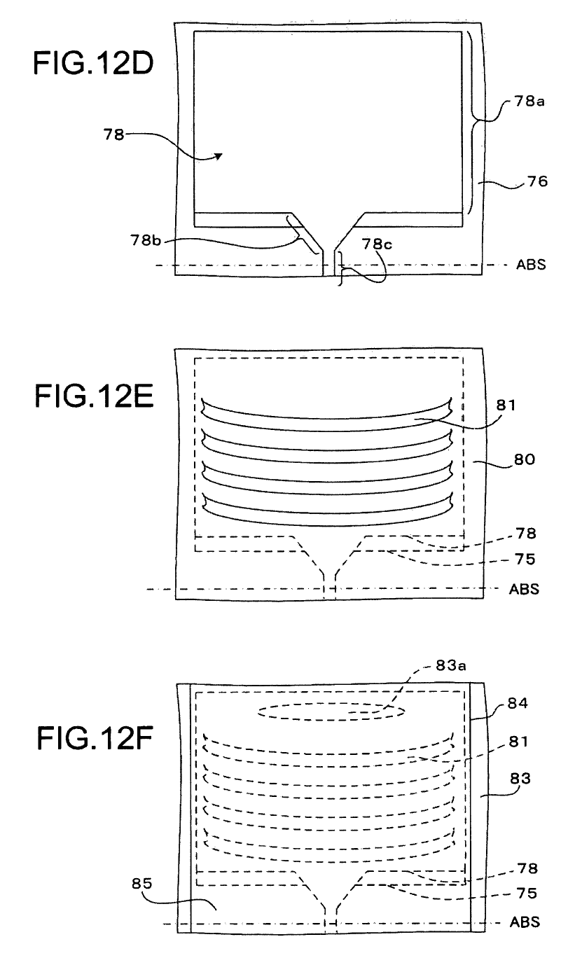

FIGS. 10A to 10K are sectional views showing steps of manufacturing a perpendicular recording magnetic head according to a second embodiment of the present invention in the height direction. Also, FIGS. 11A to 11F are sectional views showing steps of manufacturing the perpendicular recording magnetic head according to the second embodiment of the present invention in the track width direction. Also, FIGS. 12A to 12F are plan views showing steps of forming the main pole and the main pole auxiliary layer out of the steps of manufacturing the perpendicular recording magnetic head according to the second embodiment of the present invention.

Here, in FIGS. 10A to 10K, FIGS. 11A to 11F, and FIGS. 12A to 12F, the same reference symbols as those in FIG. 1 to FIG. 3 denote the same elements.

First, as shown in FIG. 10A, a magnetic reproducing head 90a is formed on a substrate 61 via a first insulating layer 62. The substrate 61 is made of the nonmagnetic insulating material, e.g., altic (Al₂O₃.TiO₂), and the first insulating layer 62 is made of an alumina (aluminium oxide: Al₂O₃) layer, for example.

The magnetic reproducing head 90a is constructed by a lower magnetic shielding layer 63, a lower gap layer 64a, a playing element 65, an upper gap layer 64b, and an upper magnetic shielding layer 66, which are formed in this order on the first insulating layer 62, for example.

The lower magnetic shielding layer 63 and the upper magnetic shielding layer 66 are formed by the sputtering method respectively, and are formed of a NiFe alloy layer that contains an iron (Fe) and a nickel (Ni) at 80 wt % and 20 wt % respectively, for example. Also, the lower gap layer 64a and the upper gap layer 64b are formed by the sputtering method respectively, and are formed of the insulating material such as alumina, for example.

As the playing element 65, for example, any one of the MR element, the GMR element, and the TMR element is formed. The playing element 65 is formed on the floating surface (ABS surface: Air Bearing Surface) of the magnetic head, i.e., the area serving as the medium opposing surface. A pair of electrodes (not shown) is connected to the playing element 65.

An isolation insulating layer 67 made of the nonmagnetic insulating material such as alumina is formed on such magnetic reproducing head 90a. Then, the perpendicular recording magnetic head is formed by steps described in the following.

First, as shown in FIG. 10B, a first return yoke layer 68 and a first insulating layer 69 are formed in this order on the isolation insulating layer 67. As the constitutive material of the first return yoke layer 68, for example, the NiFe alloy layer that contains the Fe and the Ni at 80 wt % and 20 wt % respectively is used. Also, as the constitutive material of the first insulating layer 69, for example, the alumina layer formed by the sputtering method is used.

Then, a first conductive thin film coil 70 is formed on the first insulating layer 69 in the area that is away from the area as the medium opposing surface by 1 μm or more. The first conductive thin film coil 70 is formed like a spiral shape by patterning the conductive layer such as a copper layer, or the like, which is formed by the sputtering method, the plating method, or the like, by the photolithography method, the lift-off method, or the like. A part of the first conductive thin film coil 70 has a planar shape shown in FIG. 12A.

Then, an organic insulating material such as polyimide, photoresist, or the like is formed on the first conductive thin film coil 70 and the first insulating layer 69. Then, a second insulating layer 71 for covering the first conductive thin film coil 70 is formed by patterning this organic insulating material. The second insulating layer 71 is removed from the medium opposing surface and its neighborhood.

Then, an alumina layer is formed as a third insulating layer 72 on the first and second insulating layers 69, 71. Then, an upper surface of the third insulating layer 72 is polished and planarized by the CMP method.

Then, as shown in FIG. 10C, a photoresist is coated on the upper surface of the third insulating layer 72 and then is exposed/developed. Thus, a hole forming resist pattern 73 having an opening 73a on a clearance at an almost center of the first conductive thin film coil 70 is formed.

Then, the first, second, and third insulating layers 69, 71, 72 are removed by the ion milling method of the sputter etching method through the opening 73a in the hole forming resist pattern 73. Thus, a first contact hole 72a is formed in these layers. A part of the first return yoke layer 68 is exposed from the first contact hole 72a.

Then, the hole forming resist pattern 73 is removed by using an acetone, or the like. Then, as shown in FIG. 10D, a resist pattern 74 is coated again on the third insulating layer 72 and is exposed/developed. Thus, an opening 74a that is distant from the portion acting as the medium opposing surface in the height direction of the magnetic head by 0.5 μm to 1 μm, for example, is formed. A planar shape of the opening 74a is shaped into a rectangle whose two sides being parallel with the medium opposing surface have a length x of 10 μm or more, for example, and whose two sides being perpendicular to the medium opposing surface have a length y of 10 μm, for example.

In this case, the medium opposing surface denotes a position of a surface that is to be used in future as the medium opposing surface until such surface is actually formed.

Then, as shown in FIG. 10E, a main pole auxiliary layer 75 is formed on the third insulating layer 72 by the electroless plating method or the sputtering method through the opening 74a in the resist pattern 74, for example. A thickness of the main pole auxiliary layer 75 is set to give a thickness of 0.5 μm to 2 μm, for example, a thickness of 0.6 μm after the polishing described later.

As the main pole auxiliary layer 75, the magnetic layer such as a cobalt nickel (CoFeNi) alloy layer whose saturation magnetic flux density Bs is equivalent to 1.8 T (tesla), a NiFe alloy layer whose saturation magnetic flux density Bs is equivalent to 1.5 T, or the like is formed. When the main pole auxiliary layer 75 is made of CoFeNi, compositions Co, Ni, and Fe are set to 65 wt %, 15 wt %, and 65 wt % respectively.

Then, the resist pattern 74 is removed by using an acetone, or the like. A sectional structure of a stacked structure from the main pole auxiliary layer 75 to the substrate 61 is given in FIG. 11A when the structure is viewed from the medium opposing surface side. In this case, the magnetic layer formed on the resist pattern 74 is peeled off by the lift-off method, i.e., by removing the resist pattern 74.

Then, as shown in FIG. 10F, an alumina layer or a silicon oxide (SiO₂) layer is formed as a fourth insulating layer 76 on the main pole auxiliary layer 75 and the third insulating layer 72 by the sputtering method. Then, the fourth insulating layer 76 is polished by the CMP method to expose an upper surface of the main pole auxiliary layer 75, and also the fourth insulating layer 76 and the main pole auxiliary layer 75 are planarized. In this case, the upper surface of the main pole auxiliary layer 75 is polished to adjust a thickness.

The main pole auxiliary layer 75 after polished have a planar shape shown in FIG. 12B, and its periphery is surrounded by the fourth insulating layer 76. Also, a sectional structure of a stacked structure from the fourth insulating layer 76 to the substrate 61 is given in FIG. 11B when the structure is viewed from the medium opposing surface side.

Then, as shown in FIG. 10G, a photoresist is coated on the fourth insulating layer 76 and the main pole auxiliary layer 75 and is exposed/developed, in order to form a main pole forming resist pattern 77 with a opening 77a. A part of the opening 77a overlaps with the upper surface of the main pole auxiliary layer 75 is formed.

The opening 77a of the resist pattern 77, as shown in FIG. 12C, has a square first area 77b that overlaps with the main pole auxiliary layer 75, a taper-shaped second area 77c protruded from the edge of the first area 77b on the medium opposing surface side, and a linear stripe-shaped third area 77d protruded from the second area 77c to the portion acting as the medium opposing surface. A part of the second area 77c overlaps with the main pole auxiliary layer 75, and also the third area 77d is substantially uniform in width.

Then, as shown in FIG. 10H, a main pole layer 78 is formed on the main pole auxiliary layer 75 and a part of the fourth insulating layer 76 through the opening 77a in the main pole forming resist pattern 77 by the electroless plating method or the sputtering method. The main pole layer 78 is formed to have a thickness of almost 0.1 μm to 0.3 μm, for example, a thickness of 0.2 μm, which is thinner than the main pole auxiliary layer 75, after the polishing described later.

As the main pole layer 78, the magnetic layer whose saturation magnetic flux density Bs is larger than the saturation magnetic flux density Bs of the main pole auxiliary layer 75 is formed. For example, the FeNi alloy layer whose saturation magnetic flux density Bs is 2.1 T or the CoFe alloy layer whose saturation magnetic flux density Bs is 2.3 T is formed. When the main pole layer 78 is formed of FeNi, Fe is set to 90 wt % and Ni is set to 10 wt % in composition, for example.

After the main pole forming resist pattern 77 is removed, the main pole layer 78 has a square yoke portion 78a that overlaps with the main pole auxiliary layer 75, a taper-shaped converging portion 78b protruded from the edge of the yoke portion 78a on the medium opposing surface side, and a fore-end portion 78c extended from a narrowed top end of the converging portion 78b to the medium opposing surface, as shown in FIG. 12D. In this case, the magnetic layer is peeled off from the area except the opening 77a when the main pole forming resist pattern 77 is removed by an acetone, or the like.

The yoke portion 78a, the converging portion 78b, and the fore-end portion 78c are magnetically coupled together. The fore-end portion 78c is formed like a linear stripe whose width is substantially uniform, and provides a magnetic flux saturation position of the main pole layer 78. In this case, a part of the main pole auxiliary layer 75 protrudes from the yoke portion 78a to a part of the converging portion 78b, and is not exposed from the medium opposing surface, unlike the main pole layer 78.

Here, a width of the converging portion 78b on the yoke portion 78a side is set to 10 μm or less, for example, and a core width w_{c} of the fore-end portion 78c is set to 0.1 μm, for example.

The method of forming the main pole layer 78 and the main pole auxiliary layer 75 is not limited to the electroless plating method and the sputtering method respectively. The electroplating method and other methods may be employed.

For example, when the main pole layer 78 is formed by the electroplating method, the resist film having the similar opening to that shown in the first embodiment may be used. Also, the main pole layer 78 or the main pole auxiliary layer 75 may be formed by forming the magnetic layer on the whole surface of the main pole auxiliary layer 75 and the fourth insulating layer 76, and then patterning this magnetic material layer by the photolithography method.

A sectional structure of the stacked structure from the main pole layer 78 to the substrate 61 formed by such method is given in FIG. 11C when the structure is viewed from the medium opposing surface side.

Then, as shown in FIG. 11D, the edges of at least the fore-end portion 78c of the main pole layer 78 in the core width direction on both sides are processed in the oblique direction by the ion milling or the reactive ion etching (RIE) respectively. Thus, a visor-like tapered surface is formed on the edges on both sides. As a result, a sectional shape of the fore-end portion 78c of the main pole layer 78 has a trapezoid shape. The trapezoid shape formed herein is the same shape as the inverse trapezoid shape in the first embodiment, and is shaped such that a base of the magnetic head on the trailing side is longer than a base on the leading side.

Here, in order to prevent a reduction of thickness of the main pole layer 78 by the ion milling, the upper surface of the main pole layer 78 may be covered with a mask made of photoresist, alumina, or the like prior to the ion milling.

Then, as shown in FIG. 10I, an alumina layer or a silicon oxide layer is formed as a fifth insulating layer 79 on the main pole layer 78 and the fourth insulating layer 76 by the sputtering method. Then, the fifth insulating layer 79 is polished by the CMP method to expose the upper surface of the main pole layer 78, and also the fifth insulating layer 79 and the main pole layer 78 are planarized. A periphery of the main pole layer 78 after the polishing is surrounded by the fourth insulating layer 76. In this case, the upper surface of the main pole layer 78 is polished to adjust a thickness.

Then, as shown in FIG. 10J and FIG. 11E, a gap layer 80 made of alumina is formed on the main pole layer 78 and the fifth insulating layer 79 by the sputtering method. Then, a spiral second conductive thin film coil 81 made of copper is formed on the gap layer 80. The spiral second conductive thin film coil 81 generates a magnetic field when the electric current is flown in it. A sixth insulating layer 82 made of organic material, or the like is formed on the second conductive thin film coil 81 and the gap layer 80.

The second conductive thin film coil 81 is formed such that a part of this coil is formed in a position that overlaps with an overlying area of the yoke portion 78a of the main pole layer 78, as shown in a plan view in FIG. 12E.

Then, the sixth insulating layer 82 is patterned into a predetermined shape. Then, a seventh insulating layer 83 made of alumina, for example, is formed on the gap layer 80 and the sixth insulating layer 82. Then, the surface of the seventh insulating layer 83 is planarized by the CMP method.

In this case, as steps of forming respective layers from the gap layer 80 to the seventh insulating layer 83, the same method as steps of forming the first insulating layer 69 to the seventh insulating layer 83 described above is employed.

Next, steps required until the structure shown in FIG. 10K and FIG. 12F is formed will be explained hereunder.

First, the sixth and seventh insulating layers 82, 83 and the gap layer 80 are patterned by the photolithography method. Thus, a second contact hole 83a is formed in a position that passes through a clearance in an almost center position of the second conductive thin film coil 81 and is superposed on the first contact hole 72a. Accordingly, a part of the yoke portion 78a of the main pole layer 78 is exposed in the second contact hole 83a.

Then, a second return yoke layer 84 is formed in the second contact hole 83a and on the seventh insulating layer 83 by the sputtering method. The second return yoke layer 84 is formed of the same material as the seventh insulating layer 83, for example, and is patterned by the lift-off method or the photolithography method.

The second return yoke layer 84 is formed in at least an area that overlaps with the main pole auxiliary layer 75 and contains the second contact hole 83a therein, but is removed from the shield area on the medium opposing surface side.

Accordingly, the second return yoke layer 84 is connected magnetically and structurally to the main pole layer 78, the main pole auxiliary layer 75, and the first return yoke layer 68 through the first and second contact holes 72a, 83a.

Then, the seventh insulating layer 83 is patterned by the photolithography method such that this seventh insulating layer is removed from the medium opposing surface and its neighboring shield area to expose the gap layer 80. A writing shield layer 85 connected to the second return yoke layer 84 is formed on the gap layer 80 in the shield area by the lift-off method, or the like.

As the magnetic material constituting the writing shield layer 85, the CoFeNi alloy layer whose saturation magnetic flux density Bs is equivalent to 1.8 T, for example, is formed. The CoFeNi is formed to contain Co, Ni, and Fe at 65 wt %, 15 wt %, and 65 wt % respectively, for example.

Then, the substrate 61 is cut into a predetermined shape and polished. Then, as shown in FIG. 11F, the area containing the fore-end portion 78c of the main pole layer 78 is polished, and this polished surface serves as a medium opposing surface 87. In this case, the substrate 61 is shaped and used finally as the slider 13 shown in FIG. 1.

A perpendicular recording magnetic head 90b is constructed by the stacked structure from the first return yoke layer 68 to the second return yoke layer 84. Also, the perpendicular recording magnetic head 90b as well as the magnetic reproducing head 90a constitute a perpendicular recording reproducing magnetic head 90. This perpendicular recording reproducing magnetic head 90 is used as the magnetic head element portion 14 on the slider 13 shown in FIG. 1.

Here, the term “perpendicular recording magnetic head” is used as a concept that includes both the reproducing magnetic head and the recording magnetic head, too.

The perpendicular recording reproducing magnetic head 90 formed by above steps can be manufactured by using the existing fine patterning technology, and the manufacturing method is easy. Thus, the number of steps is never increased rather than the prior art. The gap layer 80 may be formed of the nonmagnetic layer such as Ru, or the like. In such a case, an insulating film must be formed between them to prevent the connection to the second conductive thin film coil 81.

The perpendicular recording magnetic head 90b is arranged such that the first return yoke layer 68 is set on the leading side and the second return yoke layer 84 is set on the trailing side, in a state that the medium opposing surface 87 is opposed to the magnetic recording medium.

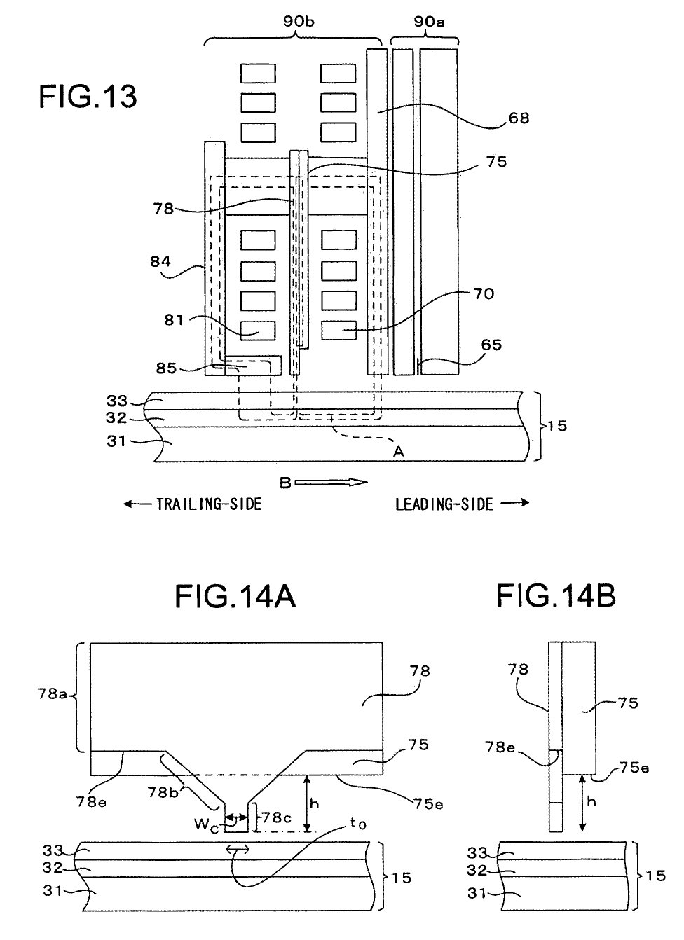

When an electric current is supplied to the first and second conductive thin film coils 70, 81 of the perpendicular recording magnetic head 90b to excite, a magnetic field A is generated in the perpendicular direction between the end surface of the fore-end portion 78c of the main pole layer 78 and the soft magnetic backing layer 32, as shown in FIG. 13. Accordingly, the recording layer 33 of the perpendicular recording medium 15 is magnetized in the perpendicular direction and the magnetic information are recorded. In this case, the substrate and the insulating layer are omitted from the illustration of the perpendicular recording magnetic head 90 shown in FIG. 13.

The magnetic field A passing through the fore-end portion 78c of the main pole layer 78 and the recording layer 33 flows back to the backing layer 32 and returns to the first and second return yoke layers 68, 84, whereby one magnetic circuit is set up.

As shown in FIGS. 14A and 14B, the main pole auxiliary layer 75 under the main pole layer 78 has a square shape like wings being spread in the track width to direction, and is formed under the yoke portion 78a and a part of the converging portion 78b of the main pole layer 78. Hence, an area of a planar shape of the main pole auxiliary layer 75 is larger than that of the yoke portion 78a of the main pole layer 78.

When a medium opposing edge 75e of the main pole auxiliary layer 75 is compare with a medium opposing edge 78e of the yoke portion 78a of the main pole layer 78, the edge 75e of the main pole auxiliary layer 75 is located closer to the medium opposing surface 78 than the edge 78e of the yoke portion 78a. The edge 75e of the main pole auxiliary layer 75 overlaps with the converging portion 78b but does not reach to the root of the fore-end portion 78c.

Since the main pole auxiliary layer 75 and the main pole layer 78 are arranged in such structure, the magnetic field which is emitted from the medium opposing surface of the fore-end portion 78c of the main pole layer 78 can be larger than that of the main pole layer of the perpendicular recording magnetic head in the prior art. Also, since a position where the magnetic flux in the main pole layer 78 is saturated comes close to the medium opposing surface 87 compared with the prior art, the unnecessary magnetic field which leaks from the fore-end portion 78c of the main pole layer 78 to the surrounding of it can be suppressed considerably. As a result, there is less the possibility that the information recorded on the adjacent track next to the writing position of the fore-end portion 78c of the main pole layer 78 is rewritten, than the prior art.

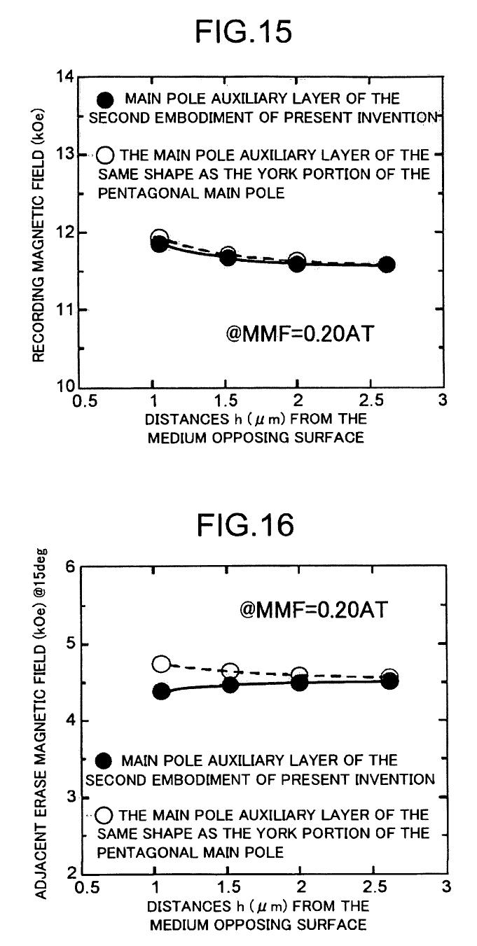

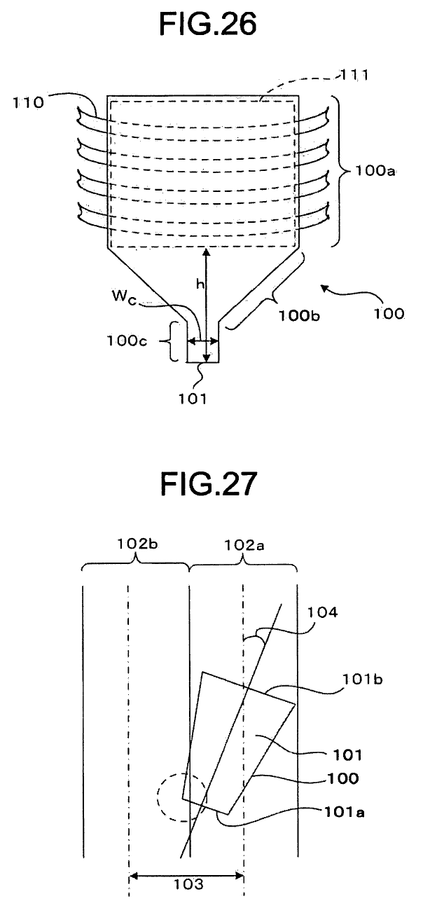

About the perpendicular recording magnetic head of the present embodiment having the main pole layer 78 and the main pole auxiliary layer 75 shown in FIGS. 14A and 14B and the perpendicular recording magnetic head in the prior art having the main pole layer 100 and the main pole auxiliary layer 111 shown in FIG. 26, the relationships between distances (position) h of the closest edges of the main pole auxiliary layers 75 and 111 from the medium opposing surface and the recording magnetic field were simulated respectively. At that time, the results shown in FIG. 15 were obtained. The recording magnetic field signifies the magnetic field that is required to record the magnetic information on the recording layer 33 and passes through the medium opposing surface of the fore-end portions 78c and 100c of the main pole layers, and is given by a magnitude when the magnetomotive force (MMF) is set to 0.2 AT.

The recording magnetic head in the prior art had the main pole layer 100 constructed by the yoke portion 100a, the converging portion 100b, and the fore-end portion 100c. A planar shape of the recording magnetic head except the fore-end portion 100c is shaped into an about pentagon. Also, the main pole auxiliary layer in the prior art is formed to overlap with the yoke portion 100a only.

In this case, thicknesses of the main pole auxiliary layers 75 and 111 were set to 0.6 μm respectively, thicknesses of the main pole layers 78 and 100 were set to 0.2 μm respectively, and the recorded track width t_{c} is set to 0.12 μm.

Here, a change in the distances h of the main pole auxiliary layers 75 and 111 brought about a change in the lengths of the fore-end portions 78c and 100c of the main pole layers 78 and 100.

In FIG. 15, the difference in respective characteristics of the recording magnetic head of the present embodiment and the recording magnetic head in the prior art is hardly found. Also, the recording magnetic field is increased as the main pole auxiliary layers 75, 111 were brought closer to the medium opposing surface, and the recording magnetic field is increased by about 4% when the distance is shortened to 1 μm from 2 μm.

Next, the relationships between distances (position) h of the closest edges of the main pole auxiliary layers 75, 111 from the medium opposing surface and the adjacent erase magnetic field were simulated respectively, in the perpendicular recording magnetic head of the present embodiment and the perpendicular recording magnetic head in the prior art. At that time, the results shown in FIG. 16 were obtained. In this case, the adjacent erase magnetic field is the magnetic field applied to the track next to the fore-end portion of the main pole, and is given by a magnitude when the magnetomotive force is set to 0.2 AT.

When the recording magnetic head having the main pole layer 100 and the main pole auxiliary layer 111 in the prior art structure is used, there is such a tendency that, as indicated by a broken line in FIG. 16, an intensity of the magnetic field applied to the adjacent track is increased as the distance h of the main pole auxiliary layer to the medium opposing surface is shortened. This is relevant to the magnetic flux saturation of the main pole layer 100, and the reason for this may be considered such that the unnecessary magnetic field, i.e., the leakage magnetic field, is generated from the fore-end portion 100c of the main pole layer 100 and spread to the surrounding as the magnetic field necessary for the recording of information is increased.

In contrast, when the recording magnetic head of the present embodiment in which the main pole auxiliary layer 75 is protruded under a part of the converging portion 78b of the main pole layer 78 is used, there is such a tendency that, as indicated by a solid line in FIG. 16, an intensity of the magnetic field applied to the adjacent track is seldom changed or is slightly reduced even when the main pole auxiliary layer 75 is brought close to the medium opposing surface by 3 μm to 1 μm. The reason for this may be considered such that the magnetic flux saturation at the fore-end portion 78c of the main pole layer 78 can be suppressed by employing the main pole layer 78 and the main pole auxiliary layer 75 shown in FIG. 13.

With the above, it is appreciated that, since the main pole auxiliary layer 75 that is joined to the yoke portion 78a of the main pole layer 78 and is coupled magnetically is protruded toward the medium opposing surface side, the magnetic flux saturation can be suppressed, generation of the adjacent erase magnetic field can be suppressed, and a component of the recording magnetic field passing through the fore-end portion 78c of the main pole layer 78 in the perpendicular direction can be increased.

In particular, it is important to suppress the adjacent erase magnetic field when further improvement of the recording density of the magnetic disk drive should be considered. In this case, when the distance of the main pole auxiliary layer 75 to the medium opposing surface is set in a range from 2 μm or less to 0.1 μm or more, an effect of suppressing an increase of the erase magnetic field is brought about conspicuously. The distance of 0.5 μm or more is preferable when a core length of the fore-end portion 78c of the main pole layer 78 is considered.

The perpendicular recording magnetic head suitable for the higher recording density can be provided in such a way that, because the main pole auxiliary layer 75 according to the present embodiment in such position is provided, the recording magnetic field can be increased by 6% or more rather than the prior art in a state the adjacent erase magnetic field is not changed.

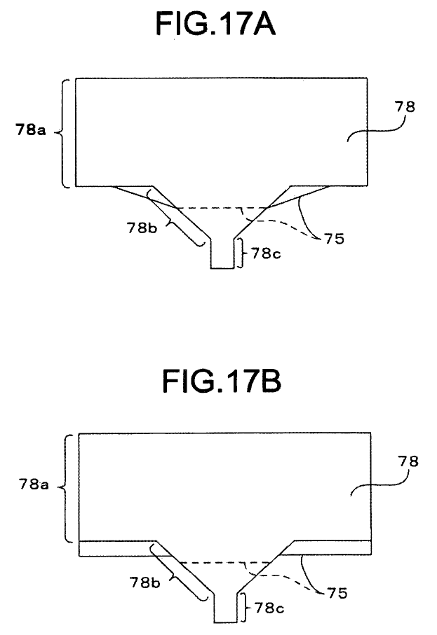

A planar shape of the area where the main pole auxiliary layer 75 protrudes from the yoke portion 78a of the main pole layer 78 toward the medium opposing surface side is not always set to the square, as shown in FIGS. 14A and 14B. For example, as shown in plan views of FIGS. 17A and 17B, the main pole auxiliary layer 75 must be protruded from a part of the converging portion 78b of the main pole layer 78 in the track width direction.

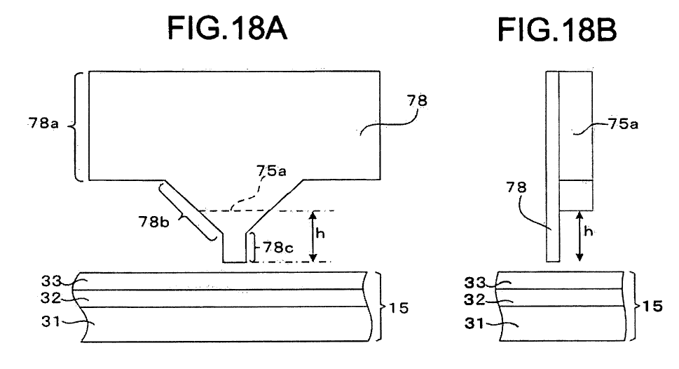

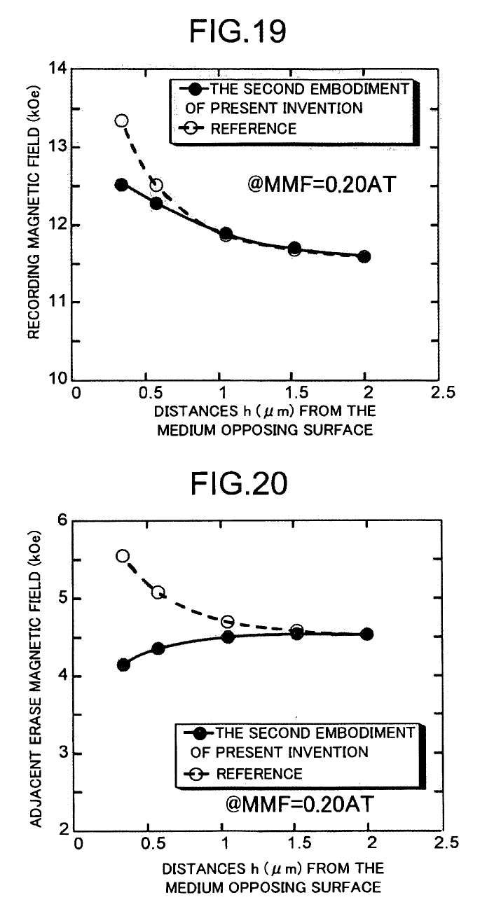

In contrast, as shown in a plan view and a side view of FIGS. 18A and 18B for reference purposes, when the planar shape of the main pole auxiliary layer 75 is set to agree with the yoke portion 78a and the converging portion 78b, not only the recording magnetic field but also the adjacent erase magnetic field is increased, as indicated by a broken line in FIG. 19 and FIG. 20, as the distance of the main pole auxiliary layer from the medium opposing surface is shortened. For this reason, such shape is not adequate to achieve an improvement of the high recording density.

Here, for the sake of comparison, the solid lines in FIG. 19 and FIG. 20 show the characteristic views of the present embodiment indicated by the solid lines in FIG. 18 and FIG. 19.

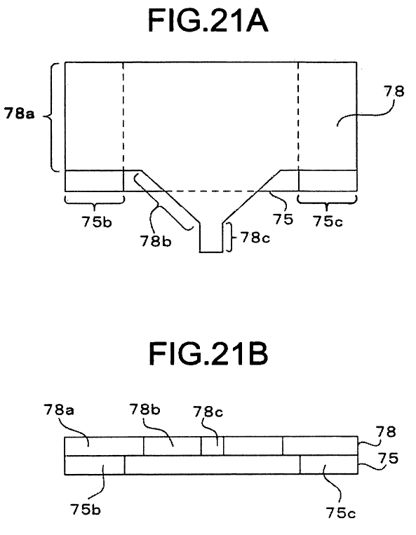

Meanwhile, as shown in a plan view and a side view of FIGS. 21A and 21B, areas 75b, 75c of the main pole auxiliary layer 75 on both sides of the converging portion 78b of the main pole layer 78 may be formed of the material whose saturation magnetic flux density is lower than that of its center area. As a result, the magnetic flux of the main pole auxiliary layer 75 can be converged into the center area, and thus the recording magnetic field passing through the fore-end portion 78c of the main pole layer 78 can be increased.

### Third Embodiment

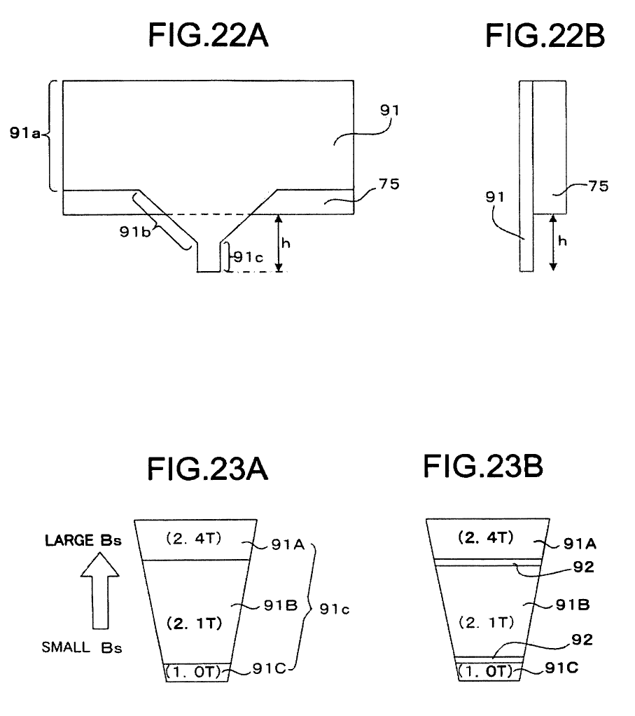

FIGS. 22A and 22B are a plan view and a side view showing a main pole and a main pole auxiliary layer constituting a perpendicular recording magnetic head according to a third embodiment of the present invention respectively. Here, in FIGS. 22A and 22B, the same reference symbols as those in FIGS. 14A and 14 denote the same elements.

In FIGS. 22A and 22B, a main pole layer 91 and the main pole auxiliary layer 75 constituting the perpendicular recording magnetic head are formed to have the same shape and the same position as those of the main pole layer 78 and the main pole auxiliary layer 75 shown in the second embodiment respectively. Also, as shown in FIG. 10K, the first and second conductive thin film coils 70, 81 are formed over and under these layers at an interval. Also, the first and second return yoke layers 68, 84 are formed over and under these coils.

The main pole auxiliary layer 75 is joined to a yoke portion 91a of the main pole layer 91 to overlap with its one surface and is coupled magnetically with it. Also, the edge of the main pole auxiliary layer 75 on the medium opposing surface side protrudes from the yoke portion 91a to a converging portion 91b toward the medium opposing surface side, and has a size that overlaps partially with the converging portion 91b.

Also, as shown in FIG. 23A, a shape of a fore-end portion 91c of the main pole layer 91, when viewed from the medium opposing surface side, has a trapezoid shape in which a base on the trailing side is wider than a base on the leading side. Also, like the first embodiment, the saturation magnetic flux of the main pole layer 91 containing the fore-end portion 91c is reduced continuously or stepwise from the trailing edge to the leading edge.

For example, as shown in FIG. 23B, a plurality of magnetic layers 91A, 91B, 91C whose saturation magnetic flux densities are different are formed in order of lower saturation magnetic flux density from the trailing edge to the leading edge. In this case, as shown in FIG. 23B, a nonmagnetic layer 92 such as Ru, or the like may be inserted between a plurality of magnetic layers 91A, 91B, and 91C respectively.

That is, the magnetic materials whose saturation magnetic flux density Bs is selected to increase continuously or stepwise in the film thickness direction from the leading side to the trailing side respectively are stacked in the main pole layer 91. Thus, a gradient of the saturation magnetic flux density Bs is given to the main pole layer 91.

For example, as shown in FIG. 23A, when the saturation magnetic flux density Bs is changed stepwise, the main pole layer 91 is constructed by the stacked films made of at least three materials whose saturation magnetic flux density Bs is different respectively. It is desirable that the first magnetic layer 91A as the uppermost layer on the trailing side should be formed of the magnetic material whose saturation magnetic flux density Bs is 2.0 T or more, the third magnetic layer 91C as the lowermost layer on the leading side should be formed of the magnetic material whose saturation magnetic flux density Bs is 1.0 T or less, and the second magnetic layer 91B formed between them should be formed of the magnetic material whose saturation magnetic flux density Bs has a middle value between them. Also, it is desirable that a ratio of the saturation magnetic flux density Bs of the first magnetic layer 91A to the third magnetic layer 91C should be set to 2.0 or more.

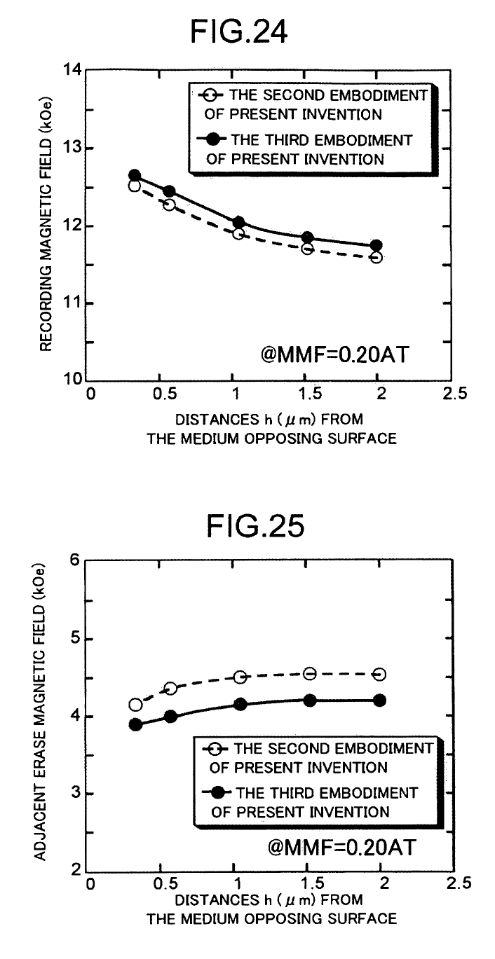

In the perpendicular recording magnetic head having the main pole layer 91 whose saturation magnetic flux density is different in the thickness direction, and the main pole auxiliary layer 75 shaped into a rectangular planar shape and formed in the position that overlaps with the yoke portion 91a to a part of the converging portion 91b of the main pole layer 91, a relationship between a distance the main pole auxiliary layer 75 from the medium opposing surface and the recording magnetic field is checked. Thus, the characteristics indicated by a solid line in FIG. 24 were obtained. In this case, a thickness of the main pole auxiliary layer 75 is set to 0.6 μm, a thickness of the main pole layer 91 is set to 0.2 μm, and a recorded track width t_{c} is set to 0.12 μm. Here, a distance between the yoke portion 91a of the main pole layer 91 and the medium opposing surface is set longer than a distance between the main pole auxiliary layer 75 and the medium opposing surface.

According to the solid line in FIG. 24, the recording magnetic field is increased as the position of the main pole auxiliary layer 75 comes closer to the medium opposing surface, the recording magnetic field necessary for the writing is increased by about 4% when the distance is shortened to 2 μm to 1 μm, and the recording magnetic field is increased by about 6% further when the distance is shortened to 1 μm to 0.3 μm. In this case, it is preferable that, when the length of the fore-end portion 91c of the main pole layer 91 is taken into consideration, the distance should be set to 0.5 μm or more.

Meanwhile, the recording magnetic field characteristic of the perpendicular recording magnetic head according to the second embodiment having the main pole layer 78 whose saturation magnetic flux density Bs is distributed uniformly in the thickness direction is given by a broken line in FIG. 24. Thus, the recording magnetic field in the present embodiment could be increased slightly larger than that in the second embodiment.

Next, in the perpendicular recording magnetic head according to the present embodiment, a relationship between a distance of the main pole auxiliary layer 75 to the medium opposing surface and the adjacent erase magnetic field was examined. Thus, the results indicated by a solid line in FIG. 25 were obtained. In this case, a value of the adjacent erase magnetic field is an intensity given when the magnetomotive force is set to 0.2 AT. Here, a thickness of the main pole auxiliary layer 75 is set to 0.6 μm, a thickness of the main pole layer 78 is set to 0.2 μam, and a recorded track width t_{c} is set to 0.12 μm.

According to the solid line in FIG. 25, in the perpendicular recording magnetic head, the adjacent erase magnetic field applied to the adjacent track is reduced by about 7% when the distance from the medium opposing surface to the main pole auxiliary layer is reduced from 2 μm to 0.3 μm.

In contrast, the adjacent erase magnetic field characteristic of the perpendicular recording magnetic head according to the second embodiment having the main pole layer 78 whose saturation magnetic flux density Bs is distributed uniformly is given by a broken line in FIG. 25. Thus, the adjacent erase magnetic field characteristic in the present embodiment could be decreased slightly smaller than that in the second embodiment.

This is so because, in the main pole layer 91 used in the present embodiment, the magnetic recording can be done by the large magnetic field at the edge of the main pole layer 91 on the trailing side caused due to a change of the saturation magnetic flux density in the film thickness direction, and hence the expansion of the magnetic field caused due to extrusion of the fore-end portion 91c of the main pole layer 91 from the track can be suppressed much more than the second embodiment.

From the above, according to the perpendicular recording magnetic head having the main pole layer 91 whose saturation magnetic flux density distribution is different in the thickness direction and the main pole auxiliary layer 75 extended from the yoke portion 91a to a part of the converging portion 91b of the main pole layer 91, generation of the erase magnetic field applied to the adjacent track can be suppressed smaller than the prior art and also the magnetic field necessary for the recording can be increased larger than the prior art.

In the present embodiment, the configuration set forth in the first embodiment may also be employed as the main pole layer 91. Also, the configuration set forth in the second embodiment may also be employed as the main pole auxiliary layer 75.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

What is claimed is:

1. A perpendicular recording magnetic head, comprising:
a first magnetic pole having a recording magnetic field output surface that is shaped into a trapezoid shape in which a base on a trailing side is longer than a base on a leading side and has a distribution of a saturation magnetic flux density of which is reduced from the trailing side to the leading side.

2. A perpendicular recording magnetic head according to claim 1, wherein the first magnetic pole is made of at least three magnetic materials having a different saturation magnetic flux density respectively.

3. A perpendicular recording magnetic head according to claim 2, wherein the three magnetic materials are constructed by a first magnetic material whose saturation magnetic flux density on the trailing side is 2.0 T or more and a second magnetic material whose saturation magnetic flux density on the leading side is 1.0 T or less, and a ratio of the saturation magnetic flux density of the first magnetic material to the saturation magnetic flux density of the second magnetic material is set to 2.0 or more.

4. A perpendicular recording magnetic head according to claim 2, wherein the three magnetic materials are formed of multi-layered films formed via a nonmagnetic material layer and having a different saturation magnetic flux density respectively.

5. A perpendicular recording magnetic head according to claim 1, further comprising:
a second magnetic pole that is coupled magnetically with a part of the first magnetic pole.

6. A perpendicular recording magnetic head mounted on a slider having a medium opposing surface, comprising:
a first magnetic pole which is coupled magnetically in order of a fore-end portion, a converging portion, and a yoke portion from the medium opposing surface, wherein the fore-end portion has a recording core; and
a second magnetic pole which is coupled magnetically at least to the yoke portion of the first magnetic pole, and whose planar shape is formed such that a length in a direction perpendicular to a core width direction of the recording core is longer than a length in the core width direction.

7. A perpendicular recording magnetic head according to claim 6, wherein an edge of a medium opposing surface side of the second magnetic pole is set closer to the medium opposing surface than an edge of the medium opposing surface side of the yoke portion.

8. A perpendicular recording magnetic head according to claim 7, wherein the edge of the medium opposing surface side of the second magnetic pole is not exposed to the medium opposing surface.

9. A perpendicular recording magnetic head according to claim 6, wherein the second magnetic pole is coupled magnetically only to the yoke portion and a part of the converging portion of the first magnetic pole.

10. A perpendicular recording magnetic head according to claim 6, wherein a width of a portion, which is coupled magnetically to the converging portion, of the second magnetic pole in the core width direction is wider than the first magnetic pole.

11. A perpendicular recording magnetic head according to claim 6, wherein a planar shape of the second magnetic pole is identical to a planar shape of the yoke portion of the first magnetic pole.

12. A perpendicular recording magnetic head according to claim 6, wherein a planar shape of the second magnetic pole is a rectangular shape.

13. A perpendicular recording magnetic head according to claim 6, wherein, in two areas on both sides of the converging portion, the second magnetic pole is formed of a magnetic material whose saturation magnetic flux density is lower than a saturation magnetic flux density of an area being formed between the two areas.

14. A perpendicular recording magnetic head according to claim 6, wherein a distance between the second magnetic pole and the medium opposing surface of the first magnetic pole is in a range of 0.5 μm to 2.0 μm.

15. A perpendicular recording magnetic head mounted on a slider having a medium opposing surface, comprising:
a first magnetic pole which is coupled magnetically in order of a fore-end portion, a converging portion, and a yoke portion from the medium opposing surface and whose saturation magnetic flux density is reduced from a trailing side to a leading side; and
a second magnetic pole which is coupled magnetically at least to the yoke portion of the first magnetic pole and whose planar shape is formed such that a length in a direction perpendicular to a core width direction of the recording core is longer than a length in the core width direction.

16. A perpendicular recording magnetic head according to claim 15, wherein the first magnetic pole has a trapezoid shape in which a base on the leading side is longer than a base on the trailing side.

17. A perpendicular recording magnetic head according to claim 15, wherein an edge of a medium opposing surface side of the second magnetic pole is set closer to the medium opposing surface than an edge of the yoke portion of the medium opposing surface side of the first magnetic pole.

18. A perpendicular recording magnetic head according to claim 15, wherein the second magnetic pole is coupled magnetically only to the yoke portion and a part of the converging portion of the first magnetic pole.

19. A magnetic disk drive, comprising:
a perpendicular recording magnetic head, comprising a first magnetic pole having a recording magnetic field output surface that is shaped into a trapezoid shape in which a base on a trailing side is longer than a base on a leading side and has a distribution of a saturation magnetic flux density of which is reduced from the trailing side to the leading side; and
a magnetic disk opposed to the perpendicular magnetic head.

20. A magnetic disk drive, comprising:
a perpendicular recording magnetic head mounted on a slider having a medium opposing surface, comprising a first magnetic pole which is coupled magnetically in order of a fore-end portion, a converging portion, and a yoke portion from the medium opposing surface, wherein and the fore-end portion has a planar shape containing a recording core, and a second magnetic pole which is coupled magnetically at least to the yoke portion of the first magnetic pole, and whose planar shape is formed such that a length in a direction perpendicular to a core width direction of the recording core is longer than a length in the core width direction; and
a magnetic disk opposed to the perpendicular magnetic head.

21. A magnetic disk drive, comprising:
a perpendicular recording magnetic head mounted on a slider having a medium opposing surface, comprising a first magnetic pole which is coupled magnetically in order of a fore-end portion, a converging portion, and a yoke portion from the medium opposing surface and whose saturation magnetic flux density is reduced from a trailing side to a leading side; and a second magnetic pole which is coupled magnetically at least to the yoke portion of the first magnetic pole and whose planar shape is formed such that a length in a direction perpendicular to a core width direction of the recording core is longer than a length in the core width direction; and
a magnetic disk opposed to the perpendicular magnetic head.
